(19) United States
(12) Patent Application Publication
(10) Pub. No.: US 2015/0376218 A1
(43) Pub. Date: Dec. 31, 2015

(54) METHOD FOR MANUFACTURING NITROGEN-CONTAINING CARBON ALLOY, NITROGEN-CONTAINING CARBON ALLOY, AND FUEL CELL CATALYST

(71) Applicant: FUJIFILM Corporation, Tokyo (JP)

(72) Inventors: Jun TANABE, Kanagawa (JP); Naoya HATAKEYAMA, Kanagawa (JP); Michio ONO, Kanagawa (JP)

(73) Assignee: FUJIFILM CORPORATION, Tokyo (JP)

(21) Appl. No.: 14/845,650

(22) Filed: Sep. 4, 2015

Related U.S. Application Data
(63) Continuation of application No. PCT/JP2014/055587, filed on Mar. 5, 2014.

(30) Foreign Application Priority Data
Mar. 8, 2013 (JP) 2013-046674

(51) Int. Cl. C07F 15/02; H01M 4/90; C07F 15/06

(52) U.S. Cl. CPC C07F 15/025; C07F 15/065; H01M 4/9008

(57) ABSTRACT

Provided is a method for manufacturing a nitrogen-containing carbon alloy having a sufficiently high oxygen reduction reaction activity, a nitrogen-containing carbon alloy, and a fuel cell catalyst. The method for manufacturing a nitrogen-containing carbon alloy comprises sintering a precursor which contains a nitrogen-containing compound and an inorganic metal salt, the nitrogen-containing compound having at least one heteroaromatic ring and a conjugated heterocycle, and the conjugated heterocycle having 12 or larger number of ring-forming atoms.

### CROSS-REFERENCE TO RELATED APPLICATIONS

This application is a Continuation of PCT International Application No. PCT/JP2014/055587 filed on Mar. 5, 2014, which claims priority under 35 U.S.C §119(a) to Japanese Patent Application No. 2013-046674 filed on Mar. 8, 2013. Each of the above application(s) is hereby expressly incorporated by reference, in its entirety, into the present application.

### TECHNICAL FIELD

This invention relates to a method for manufacturing a nitrogen-containing carbon alloy, a nitrogen-containing carbon alloy, and a fuel cell catalyst. This invention more specifically relates to a method for manufacturing a nitrogen-containing carbon alloy, which includes sintering a precursor which contains a nitrogen-containing compound and an inorganic metal salt, a nitrogen-containing carbon alloy obtained by the method, and a fuel cell catalyst using the nitrogen-containing carbon alloy.

### BACKGROUND ART

Conventional noble metal-base catalyst using platinum (Pt), palladium (Pd) or the like, featured by its high oxygen reduction reaction activity, has been used as a catalyst in solid polymer electrolyte-type fuel cells for automobile, residential-use cogeneration system and so forth. It has, however, become difficult to further disseminate such noble metal-base catalyst due to its high cost.

Technical development has therefore been forwarded on a catalyst largely reduced in the platinum consumption, or on a catalyst which can be formed without using platinum.

Carbon catalyst has been known as a catalyst which can be formed without using platinum. As a typical carbon catalyst, there has been known a nitrogen-containing carbon alloy obtained by annealing a nitrogen-containing compound. For example, Patent Literature discloses a modified product (nitrogen-containing carbon alloy) obtained by modifying a substance which contains a porphyrin complex. The porphyrin complex disclosed there has a metal element at the center, wherein the metal element and porphyrin are tightly bound through coordinate bonds.

The metal complex having a metal element is, however, difficult to purify. In the process of heating of the nitrogen-containing metal complex, it is difficult to control the decomposition speed of the nitrogen-containing ligand and the vaporization speed of the coordinated metal complex, and this makes it difficult to manufacture a target nitrogen-containing carbon alloy. Accordingly, as seen in Patent Literature 2, it has been proposed to manufacture the nitrogen-containing carbon alloy, by using an organic material which contains a nitrogen-containing compound having no central metal.

### CITATION LIST

### Patent Literature

[PATENT LITERATURE] JP-A-2012-110811

[PATENT LITERATURE] JP-A-2011-225431

### SUMMARY OF THE INVENTION

### Technical Problem

The nitrogen-containing carbon alloy having no central metal is relatively easy to purify, and the thus obtained nitrogen-containing carbon alloy can exhibit an appropriately high level of oxygen reduction reaction activity. Recent applications including fuel cell have, however, required an even higher level of oxygen reduction reaction activity, having proved in some cases that the oxygen reduction reaction activity of the conventional nitrogen-containing carbon alloy is insufficient. It has therefore been desired to manufacture a nitrogen-containing carbon alloy capable of exhibiting an even higher oxygen reduction reaction activity.

Aiming at solving the conventional problems, the present inventors then investigated into manufacture of a nitrogen-containing carbon alloy having an even higher oxygen reduction reaction activity.

### Solution to Problem

After intensive studies conducted to solve the problems, the present inventors found that a nitrogen-containing carbon alloy having a high oxygen reduction reaction activity may be obtained by manufacturing the nitrogen-containing carbon alloy, by implementing sintering a precursor which contains a nitrogen-containing compound, which has at least one heteroaromatic ring and a conjugated heterocycle, the conjugated heterocycle having the number of ring-forming atoms of 12 or larger, and an inorganic metal salt.

More specifically, this invention encompasses the configurations below:

[1] A method for manufacturing a nitrogen-containing carbon alloy,

the method comprising sintering a precursor which contains a nitrogen-containing compound and an inorganic metal salt,

the nitrogen-containing compound having at least one heteroaromatic ring and a conjugated heterocycle, and

the conjugated heterocycle having 12 or larger number of ring-forming atoms.

[2] The method for manufacturing a nitrogen-containing carbon alloy of [1], wherein the nitrogen-containing compound is represented by the formula (1) below:

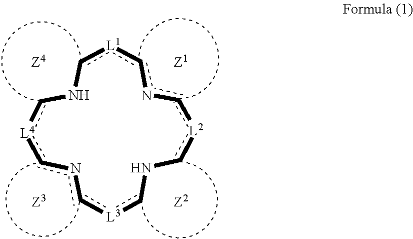

wherein each of L¹ to L⁴ independently represents a linking group, single bond or double bond, each of Z¹ to Z⁴ independently represents a cyclic structure, and at least one of L¹ to L⁴ represents a linking group having a heteroaromatic group, or at least one of Z¹ to Z⁴ contains a heteroaromatic ring.
[3] The method for manufacturing a nitrogen-containing carbon alloy of [2], wherein the nitrogen-containing compound represented by the formula (1) is represented by the formula (2) below:

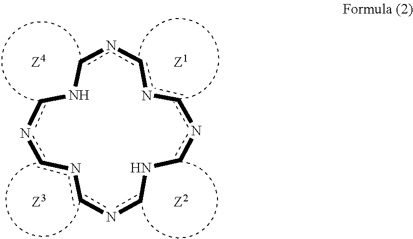

wherein each of Z¹ to Z⁴ independently represents a cyclic structure, and at least one of Z¹ to Z⁴ contains a heteroaromatic ring.
[4] The method for manufacturing a nitrogen-containing carbon alloy of [2], wherein the nitrogen-containing compound represented by the formula (1) is represented by the formula (3) below:

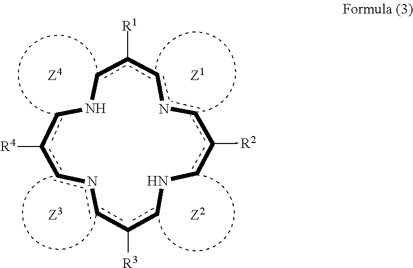

wherein each of R¹ to R⁴ independently represents a hydrogen atom or substituent, each of Z¹ to Z⁴ independently represents a cyclic structure, and at least one of R¹ to R⁴ represents a heteroaromatic group, or at least one of Z¹ to Z⁴ contains a heteroaromatic ring.
[5] The method for manufacturing a nitrogen-containing carbon alloy of [2], wherein the nitrogen-containing compound represented by the formula (1) is represented by the formula (4) below:

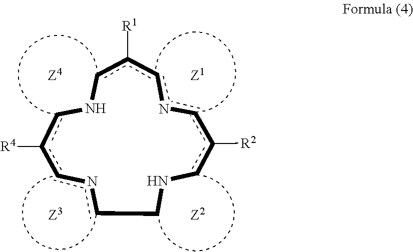

wherein each of R¹, R² and R⁴ independently represents a hydrogen atom or substituent, each of Z¹ to Z⁴ independently represents a cyclic structure, and at least one of R¹, R² and R⁴ represents a heteroaromatic group, or at least one of Z¹ to Z⁴ contains a heteroaromatic ring.
[6] The method for manufacturing a nitrogen-containing carbon alloy of [2], wherein the nitrogen-containing compound represented by the formula (1) is represented by the formula (5) below:

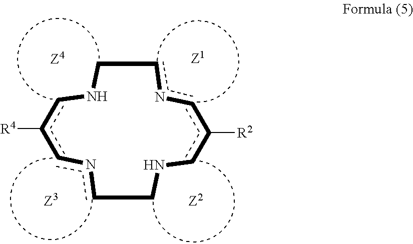

wherein each of R² and R⁴ independently represents a hydrogen atom or substituent, each of Z¹ to Z⁴ independently represents a cyclic structure, and at least one of R² and R⁴ represents a heteroaromatic group, or at least one of Z¹ to Z⁴ contains a heteroaromatic ring.
[7] The method for manufacturing a nitrogen-containing carbon alloy of [2], wherein the nitrogen-containing compound represented by the formula (1) is represented by the formula (6) below:

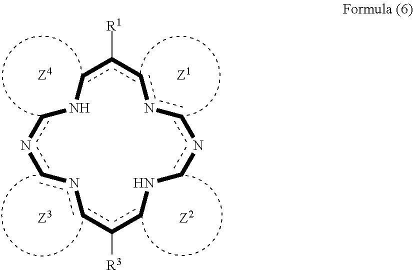

wherein each of R¹ and R³ independently represents a hydrogen atom or substituent, each of Z¹ to Z⁴ independently represents a cyclic structure, and at least one of R¹ and R³ represents a heteroaromatic group, or at least one of Z¹ to Z⁴ contains a heteroaromatic ring.
[8] The method for manufacturing a nitrogen-containing carbon alloy of any one of [1] to [7], wherein the heteroaromatic ring, or the heteroaromatic ring which configures the heteroaromatic group is a six-membered heteroaromatic ring.
[9] The method for manufacturing a nitrogen-containing carbon alloy of any one of [1] to [8], wherein the heteroaromatic ring, or the heteroaromatic ring which configures the heteroaromatic group is a pyridine ring or pyrimidine ring.
[10] The method for manufacturing a nitrogen-containing carbon alloy of any one of [1] to [9], wherein the nitrogen-containing compound has two or more heteroaromatic rings.
[11] The method for manufacturing a nitrogen-containing carbon alloy of any one of [1] to [10], wherein the conjugated heterocycle is a porphyrin ring.
[12] The method for manufacturing a nitrogen-containing carbon alloy of any one of [1] to [11], wherein the nitrogen-containing compound is at least one species selected from pyridylporphyrin excluding metal complex, and, salt of pyridylporphyrin excluding metal complex.
[13] The method for manufacturing a nitrogen-containing carbon alloy of any one of [1] to [12], wherein the precursor further contains an organometallic complex.
[14] The method for manufacturing a nitrogen-containing carbon alloy of [13], wherein the organometallic complex is a β-diketone metal complex.
[15] The method for manufacturing a nitrogen-containing carbon alloy of [13] or [14], wherein the organometallic complex is iron(II) acetylacetonate complex.
[16] The method for manufacturing a nitrogen-containing carbon alloy of any one of [1] to [15], wherein the inorganic metal salt is an inorganic metal chloride.
[17] The method for manufacturing a nitrogen-containing carbon alloy of any one of [1] to [16], wherein a metal species of the inorganic metal is Fe or Co.
[18] The method for manufacturing a nitrogen-containing carbon alloy of any one of [1] to [17], wherein the inorganic metal salt is a hydrate salt.
[19] The method for manufacturing a nitrogen-containing carbon alloy of any one of [1] to [18], wherein the sintering is sintering the precursor at 400° C. or above.
[20] The method for manufacturing a nitrogen-containing carbon alloy of any one of [1] to [19], further comprising, succeeding to the sintering, rinsing the sintered nitrogen-containing carbon alloy with an acid.
[21] A nitrogen-containing carbon alloy manufactured by a method described in any one of, [1] to [21].
[22] A fuel cell catalyst comprising a nitrogen-containing carbon alloy described in [21].

### Advantageous Effects of Invention

According to the method for manufacturing a nitrogen-containing carbon alloy of this invention, it is now possible to obtain a nitrogen-containing carbon alloy having a sufficiently high oxygen reduction reaction activity. As a consequence, the nitrogen-containing carbon alloy obtained by the method for manufacturing a nitrogen-containing carbon alloy of this invention is usable as a carbon catalyst, and may suitably be used as fuel cell catalyst or environmental catalyst.

### BRIEF DESCRIPTION OF DRAWINGS

FIG. 1 A schematic configuration diagram of a fuel cell using the nitrogen-containing carbon alloy of this invention.

FIG. 2 A schematic configuration diagram of an electric double-layer capacitor using the nitrogen-containing carbon alloy of this invention.

### DESCRIPTION OF EMBODIMENTS

This invention will be detailed below. Although the description below regarding constituent features may be made on representative embodiments of this invention, this invention is not limited to these embodiments. In this specification, all numerical ranges expressed using “to” with preceding and succeeding numerals are defined to contain these numerals as the lower and upper limit values.

The substituent in the context of this invention will suffice if it is substitutive, and is exemplified by halogen atom (fluorine atom, chlorine atom, bromine atom or iodine atom), hydroxy group, cyano group, aliphatic group (including aralkyl group, cycloalkyl group, reactive methine group, etc.), aryl group (position of substitution is arbitrary), heterocyclic group (position of substitution is arbitrary), acyl group, aliphatic oxy group (including groups which repetitively contain alkoxy group, alkylenoxy group, ethylenoxy group or propylenoxy group unit), aryloxy group, heterocyclic oxy group, aliphatic carbonyl group, arylcarbonyl group, heterocyclic carbonyl group, aliphatic oxycarbonyl group, aryloxycarbonyl group, heterocyclic oxycarbonyl group, carbamoyl group, sulfonylcarbamoyl group, acylcarbamoyl group, sulfamoylcarbamoyl group, thiocarbamoyl group, aliphatic carbonyloxy group, aryloxycarbonyloxy group, heterocyclic carbonyloxy group, amino group, aliphatic amino group, arylamino group, heterocyclic amino group, acylamino group, aliphatic oxyamino group, aryloxyamino group, sulfamoylamino group, acylsulfamoylamino group, oxamoylamino group, aliphatic oxycarbonylamino group, aryloxycarbonylamino group, heterocyclic oxycarbonylamino group, carbamoylamino group, mercapto group, aliphatic thio group, arylthio group, heterocyclic thio group, alkylsulfinyl group, arylsulfinyl group, aliphatic sulfonyl group, arylsulfonyl group, heterocyclic sulfonyl group, sulfamoyl group, aliphatic sulfonylureido group, arylsulfonylureido group, heterocyclic sulfonylureido group, aliphatic sulfonyloxy group, arylsulfonyloxy group, heterocyclic sulfonyloxy group, sulfamoyl group, aliphatic sulfamoyl group, arylsulfamoyl group, heterocyclic sulfamoyl group, acylsulfamoyl group, sulfonylsulfamoyl group or salts thereof, carbamoylsulfamoyl group, sulfonamide group, aliphatic ureido group, arylureido group, heterocyclic ureido group, aliphatic sulfonamide group, arylsulfonamide group, heterocyclic sulfonamide group, aliphatic sulfinyl group, arylsulfinyl group, nitro group, nitroso group, diazo group, azo group, hydrazino group, dialiphatic oxyphosphinyl group, diaryloxyphosphinyl group, silyl group (for example, trimethylsilyl, t-butyldimethylsilyl, phenyldimethylsilyl), silyloxy group (for example, trimethylsilyloxy, t-butyldimethylsilyloxy), borono group, and ionic hydrophilic group (for example, carboxy group, sulfo group, phosphono group, and quaternary ammonium group). Each substituent in this group may additionally be substituted, wherein the additional substituent is exemplified by those selected from the substituents explained above.

### [Method for Manufacturing Nitrogen-Containing Carbon Alloy]

The method for manufacturing a nitrogen-containing carbon alloy of this invention (also referred to as “manufacturing method of this invention”, hereinafter) includes sintering a precursor which contains a nitrogen-containing compound and an inorganic metal salt. The nitrogen-containing compound has at least one heteroaromatic ring and a conjugated heterocycle, wherein the conjugated heterocycle has 12 or more ring-forming atoms.

In the method for manufacturing a nitrogen-containing carbon alloy of this invention, the sintering the precursor preferably includes:

(1) a step of preparing the precursor by mixing a nitrogen-containing compound, with an inorganic metal salt which contains one species of more of Fe, Co, Ni, Mn and Cr;

(2) a temperature elevating step, heating the precursor under an inert atmosphere, from room temperature up to a carbonization temperature at a heating rate of 1° C./min or faster and 1000° C./rain or slower;

(3) a carbonization step, keeping the product at 400° C. to 1000° C., for 0.1 to 100 hours; and

(4) a cooling step, cooling the product from the carbonization temperature down to room temperature.

In the step of sintering the precursor,

(5) after the carbonization, the nitrogen-containing carbon alloy may be cooled down to room temperature, and may be crushed.

The method for manufacturing a nitrogen-containing carbon alloy of this invention further preferably includes, succeeding to the step of sintering,

(6) a step of rinsing the sintered nitrogen-containing carbon alloy with an acid, and more preferably includes,

(7) succeeding to the acid rinsing, a step of re-sintering the acid-rinsed, nitrogen-containing carbon alloy.

The method for manufacturing a nitrogen-containing carbon alloy of this invention will be explained below, according to the order of steps (1) to (7).

### (1) Step of Preparing Precursor

In the step of preparing a precursor, the precursor is prepared by mixing a nitrogen-containing compound and an inorganic metal salt. The nitrogen-containing compound and the inorganic metal salt will be detailed below.

### <Nitrogen-Containing Compound>

The nitrogen-containing compound is a compound which contains nitrogen atoms. The nitrogen-containing compound has at least one heteroaromatic ring, and a conjugated heterocycle. The conjugated heterocycle has 12 or more ring-forming atoms.

In this invention, the nitrogen-containing compound is defined to contain no nitrogen-containing metal complex. This is because the nitrogen-containing metal complex is difficult to purify, and when decomposed during sintering, the decomposition speed of the nitrogen-containing ligand and the vaporization speed of the coordinated metal complex will not be controlled due to constantness of the compositional ratio between the nitrogen-containing ligand and the metal complex, and this makes it difficult to manufacture a target nitrogen-containing carbon alloy. This is also because the nitrogen-containing carbon alloy having a central metal tends to degrade the catalytic activity when used as a catalyst. Even if the nitrogen-containing metal complex and a low-molecular-weight organic compound were mixed, the crystal of the nitrogen-containing metal complex will decompose and the metal will directly be reduced, so that the thus-produced neighboring metal atoms will be more likely to agglomerate and crystallize. Since the metal will be removed by acid rinsing, the resultant nitrogen-containing carbon alloy will become non-uniform, only to give a function poorer than intended.

The nitrogen-containing compound is preferably represented by the formula (1) below. The nitrogen-containing compound is now understood to include tautomers of the compound represented by the formula (1) below, and, salts thereof or hydrates thereof.

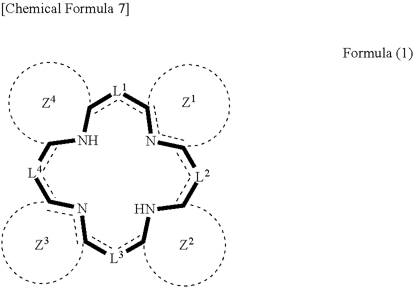

In the formula (1), each of L¹ to L⁴ independently represents a linking group, single bond or double bond, and each of Z¹ to Z⁴ independently represents a cyclic structure. At least one of L¹ to L⁴ represents a linking group having a heteroaromatic group, or at least one of Z¹ to Z⁴ contains a heteroaromatic ring. Note that the dotted lines illustrated along the valence bonds in the formula (1) (dashed lines configuring Z¹ to Z⁴ are not included) indicate that the bonds may also be double bonds.

The nitrogen-containing compound represented by the formula (1) is preferably represented by the formula (2) below:

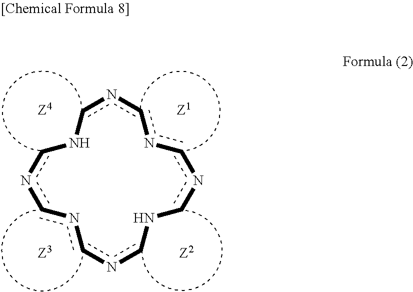

In the formula (2), each of Z¹ to Z⁴ independently represents a cyclic structure, where at least one of Z¹ to Z⁴ contains a heteroaromatic ring.

The nitrogen-containing compound represented by the formula (1), is preferably represented by the formula (3).

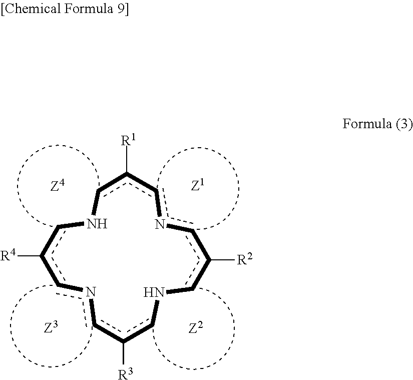

In the formula (3), each of R¹ to R⁴ independently represents a hydrogen atom or substituent, and each of Z¹ to Z⁴ independently represents a cyclic structure. At least one of R¹ to R⁴ represents a heteroaromatic group, or at least one of Z¹ to Z⁴ contains a heteroaromatic ring.

The nitrogen-containing compound represented by the formula (1) is preferably represented by the formula (4) below.

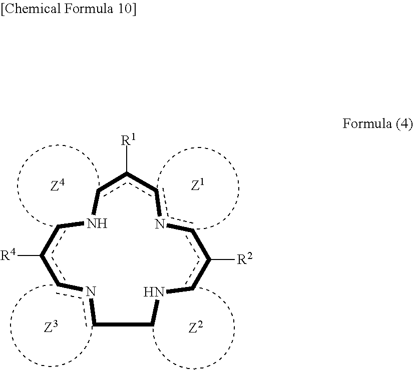

In the formula (4), each of R¹, R² and R⁴ independently represents a hydrogen atom or substituent, and each of Z¹ to Z⁴ independently represents a cyclic structure. Note at least one of R¹, R² and R⁴ represents a heteroaromatic group, or at least one of Z¹ to Z⁴ contains a heteroaromatic ring.

The nitrogen-containing compound represented by the formula (1) is more preferably represented by the formula (5) below:

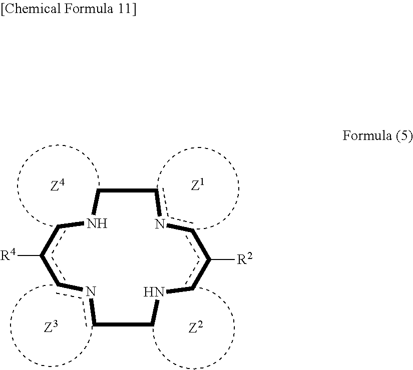

In the formula (5), each of R² and R⁴ independently represents a hydrogen atom or substituent, and each of Z¹ to Z⁴ independently represents a cyclic structure. Note that at least one of R² and R⁴ represents a heteroaromatic group, or at least one of Z¹ to Z⁴ contains a heteroaromatic ring.

The nitrogen-containing compound represented by the formula (1) is further preferably represented by the formula (6) below:

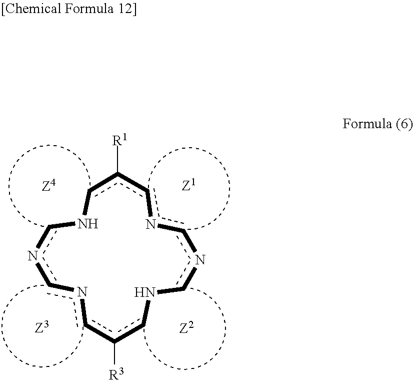

In the formula (6), each of R¹ and R³ independently represents a hydrogen atom or substituent, and each of Z¹ to Z⁴ independently represents a cyclic structure. At least one of R¹ and R³ represents a heteroaromatic group, or at least one of Z¹ to Z⁴ represents a heteroaromatic ring.

In this invention, each of the heteroaromatic ring, and the heteroaromatic ring which composes the heteroaromatic group may be a five- to seven-membered heterocyclic which contains 1 to 3, substituted or unsubstituted hetero atoms selected from nitrogen atom, oxygen atom and sulfur atom; such as pyridyl group, quinazolyl group, pyrimidyl group, pyrrolyl group, imidazolyl group, furyl group, thienyl group, and imidazolyl group. Among them, each of the heteroaromatic ring, and the heteroaromatic ring which composes the heteroaromatic group is preferably a six-membered heteroaromatic ring. More specifically, in the formulae (1) to (6), the heteroaromatic ring which composes the linking group having the heteroaromatic group, represented by L¹ to L⁴, is preferably a six-membered heteroaromatic ring. The heteroaromatic ring represented by Z¹ to Z⁴ is preferably a six-membered heteroaromatic ring. Moreover heteroaromatic ring which composes the heteroaromatic group, represented by R¹ to R⁴, is preferably a six-membered heteroaromatic ring.

In this invention, each of the heteroaromatic ring, and the heteroaromatic ring which composes the heteroaromatic group is preferably a pyridine ring or pyrimidine ring. In other words, in the formula (1), the heteroaromatic ring which composes the linking group having the heteroaromatic group, represented by L¹ to L⁴, is preferably a pyridine ring or pyrimidine ring. Again in (1) to (6), the heteroaromatic ring represented by Z¹ to Z⁴ is preferably a pyridine ring or pyrimidine ring. Moreover, in (3) to (6), heteroaromatic ring which composes the heteroaromatic group, represented by R¹ to R⁴, is preferably a pyridine ring or pyrimidine ring.

The nitrogen-containing compound usable in this invention preferably has two or more heteroaromatic rings, more preferably three or more heteroaromatic rings, and even more preferably four heteroaromatic rings. When the nitrogen-containing compound has more than a certain number of heteroaromatic rings, the metal species (M) and the heteroaromatic ring will become more likely to form a complex. As a consequence, active sites of oxygen reduction reaction (ORR) may be formed in a highly condensed manner, and thereby the nitrogen-containing compound will have a high oxygen reduction reaction activity.

In the process of interaction between the metal species (M) and the heteroaromatic ring, the nitrogen-containing compound having two or more heteroaromatic rings can form a structure in which the active sites of oxygen reduction reaction (ORR) are highly condensed and controlled, due to alignment and orientation of the heteroaromatic rings by themselves, and will therefore have a still higher oxygen reduction reaction activity.

In the formula (1), it is preferable that at least one of L¹ to L⁴ represents a linking group having a heteroaromatic group, more preferable that two or more of L¹ to L⁴ represent the linking group having a heteroaromatic group, even more preferable that three or more of L¹ to L⁴ represent the linking group having a heteroaromatic group, and particularly preferable that all of L¹ to L⁴ represent the linking group having a heteroaromatic group. If none of L¹ to L⁴ is the linking group having a heteroaromatic group, each of L¹ to L⁴ may independently represent a single bond or double bond. The linking group is specifically exemplified by —NR⁸— (R⁸ represents a hydrogen atom, optionally-substituted alkyl group or optionally-substituted aryl group, wherein hydrogen atom is preferable), —SO₂—, —CO—, substituted or unsubstituted alkylene group, substituted or unsubstituted alkenylene group, alkynylene group, substituted or unsubstituted phenylene group, substituted or unsubstituted biphenylene group, substituted or unsubstituted naphthylene group, —O—, —S— and —SO—, and groups obtained by combining two or more of them.

In the formulae (1) to (6), it is preferable that at least one of Z¹ to Z⁴ contains an heteroaromatic ring, more preferable that two or more of Z¹ to Z⁴ contain a heteroaromatic ring, even more preferable that three or more of Z¹ to Z⁴ contain a heteroaromatic ring, and particularly preferable that all of Z¹ to Z⁴ contain a heteroaromatic ring. If none of Z¹ to Z⁴ contains a heteroaromatic ring, each of which may be a nitrogen atom-containing heterocycle. The heterocycle is exemplified, without specifying the position of substitution, by pyridine ring, pyrazine ring, pyrimidine ring, triazine ring, quinoline ring, isoquinoline ring, quinazoline ring, quinoxaline ring, pyrrole ring, indole ring, pyrazole ring, imidazole ring, benzoimidazole ring, oxazole ring, benzooxazole ring, thiazole ring, benzothiazole ring, pyrrolidine ring, piperidine ring, piperazine ring, and imidazole ring, thiazole ring.

In the formulae (3) to (6), it is preferable that at least one of R¹ to R⁴ represents a heteroaromatic group, more preferable that two or more of R¹ to R⁴ represent a heteroaromatic group, even more preferable that three or more of R¹ to R⁴ represent a heteroaromatic group, and particularly preferable that all of R¹ to R⁴ represent a heteroaromatic group. In the formula (4), it is preferable that at least one of R¹, R² and R⁴ represents a heteroaromatic group, more preferable that two or more of R¹, R² and R⁴ represent a heteroaromatic group, and even more preferable that all of R¹, R² and R⁴ represent a heteroaromatic group. In the formula (5), it is preferable that at least one of R² and R⁴ represents a heteroaromatic group, and more preferable that R² and R⁴ represent a heteroaromatic group. In the formula (6), it is preferable that at least one of R¹ and R³ represents a heteroaromatic group, and is more preferable that R¹ and R³ represent a heteroaromatic group.

When none of R¹ to R⁴ represents a heteroaromatic group, R¹ to R⁴ may be a hydrogen atom or optionally-substituted substituent. When none of R¹ to R⁴ represents a heteroaromatic group, specific examples of the substituent which can be possessed by R¹ to R⁴ include halogen atom (fluorine atom, chlorine atom, bromine atom or iodine atom), hydroxy group, cyano group, aliphatic group (including aralkyl group, cycloalkyl group, and reactive methine group), vinyl group, allyl group, acetylenyl group, aryl group (position of substitution is arbitrary), acyl group, aliphatic oxy group (including alkoxy group or, alkyleneoxy group, and group containing a repeating unit such as ethyleneoxy group or propyleneoxy group), aryloxy group, heterocyclic oxy group, aliphatic carbonyl group, arylcarbonyl group, heterocyclic carbonyl group, aliphatic oxycarbonyl group, aryloxycarbonyl group, heterocyclic oxycarbonyl group, carbamoyl group, sulfonylcarbamoyl group, acylcarbamoyl group, sulfamoylcarbamoyl group, thiocarbamoyl group, aliphatic carbonyloxy group, aryloxycarbonyloxy group, heterocyclic carbonyloxy group, amino group, aliphatic amino group, arylamino group, heterocyclic amino group, acylamino group, aliphatic oxyamino group, aryloxyamino group, sulfamoylamino group, acylsulfamoylamino group, oxamoylamino group, aliphatic oxycarbonylamino group, aryloxycarbonylamino group, heterocyclic oxycarbonylamino group, carbamoylamino group, mercapto group, aliphatic thio group, arylthio group, heterocyclic thio group, alkylsulfinyl group, arylsulfinyl group, aliphatic sulfonyl group, arylsulfonyl group, heterocyclic sulfonyl group, sulfamoyl group, aliphatic sulfonylureido group, arylsulfonylureido group; heterocyclic sulfonylureido group, aliphatic sulfonyloxy group, arylsulfonyloxy group, heterocyclic sulfonyloxy group, sulfamoyl group, aliphatic sulfamoyl group, arylsulfamoyl group, heterocyclic sulfamoyl group, acylsulfamoyl group, sulfonylsulfamoyl group or salt thereof, carbamoylsulfamoyl group, sulfonamide group, aliphatic ureido group, arylureido group, heterocyclic ureido group, aliphatic sulfonamide group, arylsulfonamide group, heterocyclic sulfonamide group, aliphatic sulfinyl group, arylsulfinyl group, nitro group, nitroso group, diazo group, azo group, hydrazino group, dialiphatic oxyphosphinyl group, diaryloxyphosphinyl group, silyl group (for example, trimethylsilyl, t-butyldimethylsilyl, phenyldimethyl silyl), silyloxy group (for example, trimethylsilyloxy, t-butyldimethylsilyloxy), borono group, and ionic hydrophilic group (for example, carboxy group, sulfo group, phosphono group and quaternary ammonium group).

The substituent containing an unsaturated group is more preferable, and vinyl group, allyl group, acetylenyl group, and aryl group (phenyl group, naphthyl group, phenanthrene group, anthracenyl group, triphenyl group, pyrenyl group, perylenyl group, benzhydryl group, benzyl group, cynnamyl group, cumenyl group, mesityl group, phenylethyl group, styryl group, tolyl group, trityl group, xylyl group) are more preferable. Each substituent in this group may additionally be substituted, wherein the additional substituent is exemplified by those selected from the substituents and heteroaromatic groups (position of substitution are arbitrary) explained above.

The above-described heteroaromatic ring, or the heteroaromatic ring which configures the heteroaromatic group are preferably a pyridine ring or pyrimidine ring. When the heteroaromatic ring, or the heteroaromatic ring which configures the heteroaromatic group is a pyridine ring or pyrimidine ring, the nitrogen atom of the pyridine ring or pyrimidine ring preferably resides on the para position, relative to the position where the ring is bound. By disposing the nitrogen atom in such position, the metal species (M) and the heteroaromatic ring will become more likely to form a complex. In addition, it also becomes possible to control the orientation of the substituent which forms the active site of oxygen reduction reaction (ORR), so that the active site of oxygen reduction reaction (ORR) may be formed in a highly condensed manner, and thereby the nitrogen-containing compound will have a high oxygen reduction reaction activity.

In this invention, the nitrogen-containing compound has a conjugated heterocycle, wherein it suffices that the conjugated heterocycle has 12 or more ring-forming atoms, preferably has 14 or more, and even more preferably 16 or more.

In this invention, the conjugated heterocycle is preferably a porphyrin ring. More specifically, the nitrogen-containing compound used in this invention is preferably a pyridyl porphyrin and a salt thereof. Note that the metal complex is not included in the pyridylporphyrin and the salt thereof.

Specific examples of the nitrogen-containing compound represented by the formula (1) include the compounds below. This invention is, however, not limited to the specific examples below.

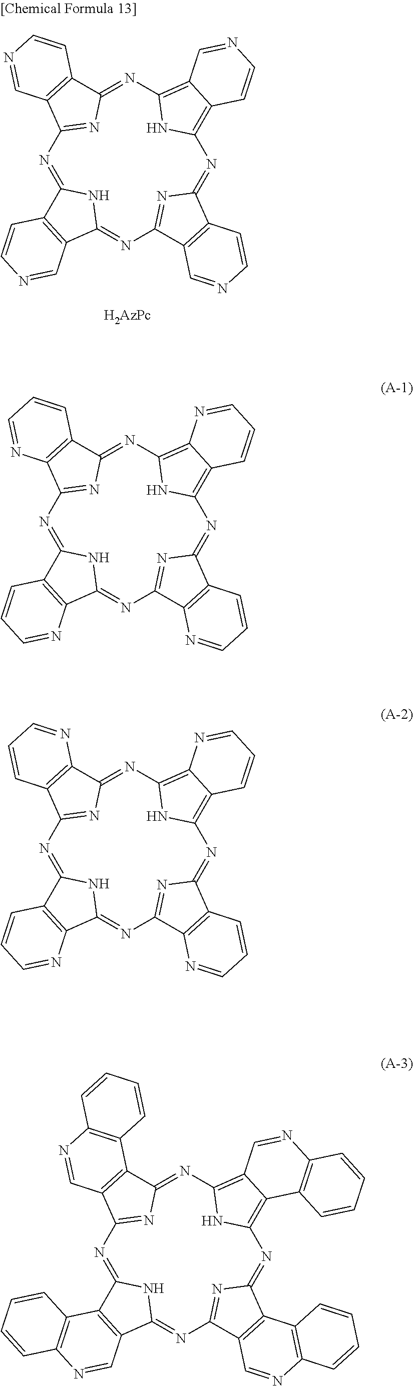 [SMILES: c1cc2c(cn1)-c1nc-2nc2[nH]c(nc3nc(nc4[nH]c(n1)c1ccncc41)-c1cnccc1-3)c1ccncc21 ; c1cnc2c(c1)-c1nc-2nc2[nH]c(nc3nc(nc4[nH]c(n1)c1ncccc41)-c1cccnc1-3)c1ncccc21 ; c1cnc2c(c1)-c1nc-2nc2[nH]c(nc3nc(nc4[nH]c(n1)c1cccnc41)-c1ncccc1-3)c1cccnc21 ; c1ccc2c3c(cnc2c1)-c1nc-3nc2[nH]c(nc3nc(nc4[nH]c(n1)c1c5ccccc5ncc41)-c1cnc4ccccc4c1-3)c1c3ccccc3ncc21]

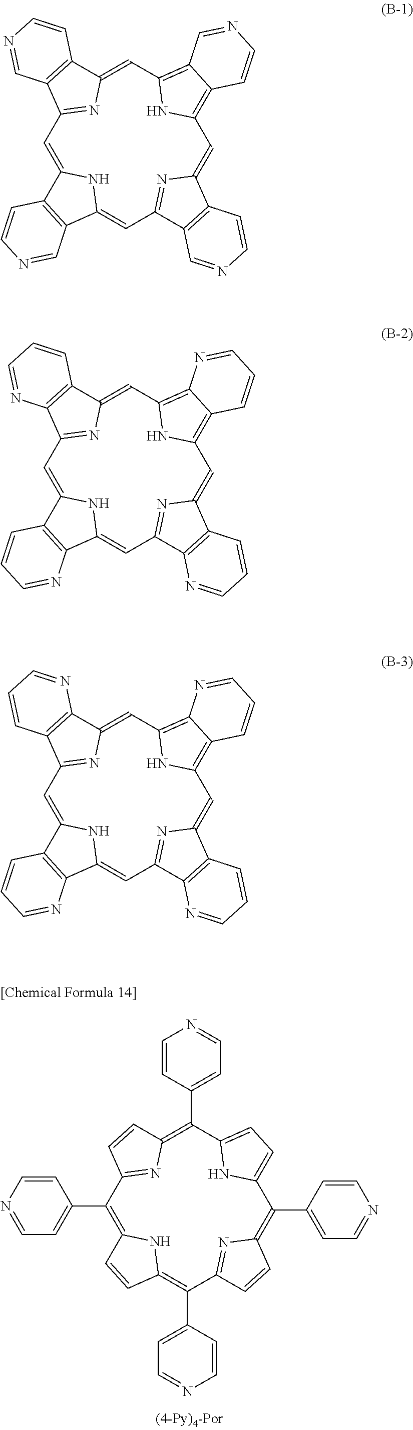 [SMILES: c1cc2c(cn1)-c1cc3[nH]c(cc4nc(cc5[nH]c(cc-2n1)c1cnccc51)-c1ccncc1-4)c1cnccc31 ; c1cnc2c(c1)-c1cc3[nH]c(cc4nc(cc5[nH]c(cc-2n1)c1cccnc51)-c1ncccc1-4)c1cccnc31 ; c1cnc2c(c1)-c1cc3[nH]c(cc4nc(cc5[nH]c(cc-2n1)c1ncccc51)-c1cccnc1-4)c1ncccc31 ; C1=Cc2nc1c(-c1ccncc1)c1ccc([nH]1)c(-c1ccncc1)c1nc(c(-c3ccncc3)c3ccc([nH]3)c2-c2ccncc2)C=C1]

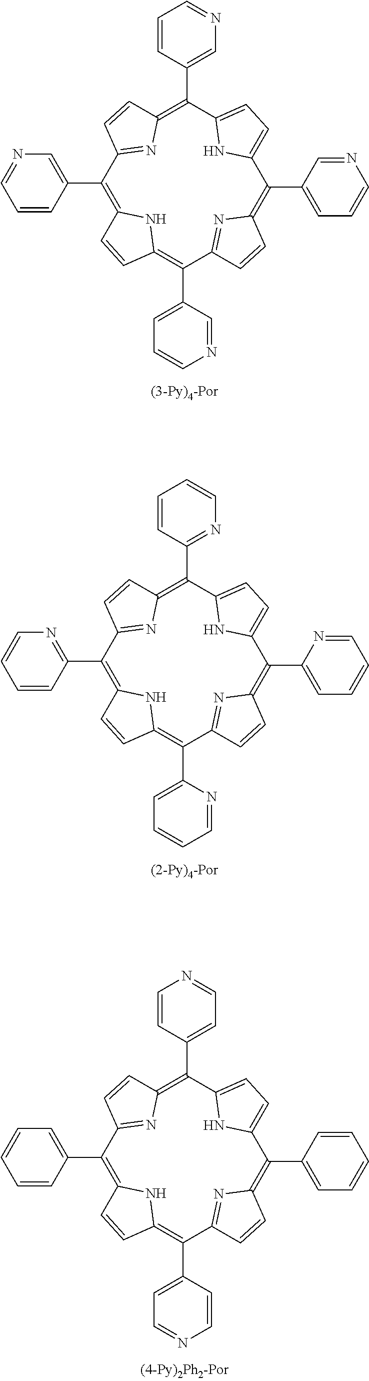 [SMILES: C1=Cc2nc1c(-c1cccnc1)c1ccc([nH]1)c(-c1cccnc1)c1nc(c(-c3cccnc3)c3ccc([nH]3)c2-c2cccnc2)C=C1 ; C1=Cc2nc1c(-c1ccccn1)c1ccc([nH]1)c(-c1ccccn1)c1nc(c(-c3ccccn3)c3ccc([nH]3)c2-c2ccccn2)C=C1 ; C1=Cc2nc1c(-c1ccccc1)c1ccc([nH]1)c(-c1ccncc1)c1nc(c(-c3ccccc3)c3ccc([nH]3)c2-c2ccncc2)C=C1]

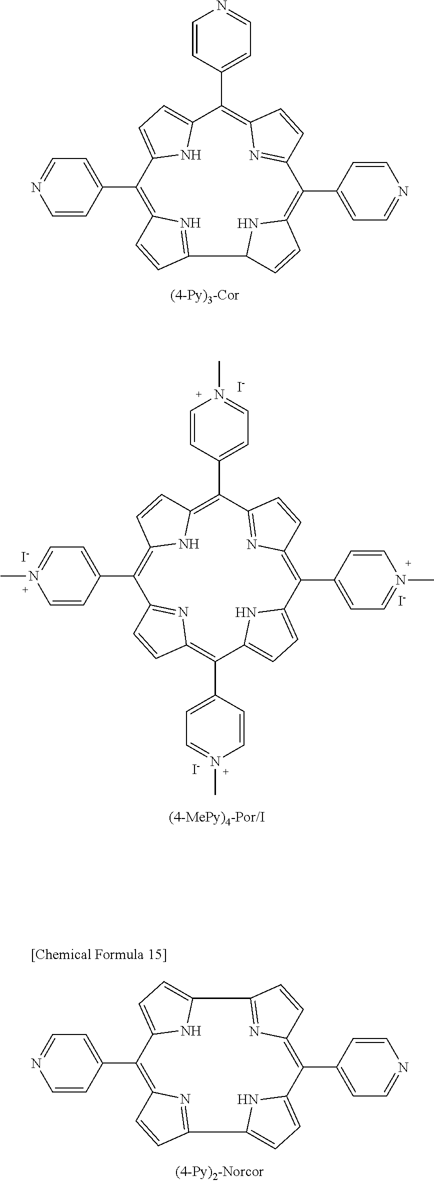

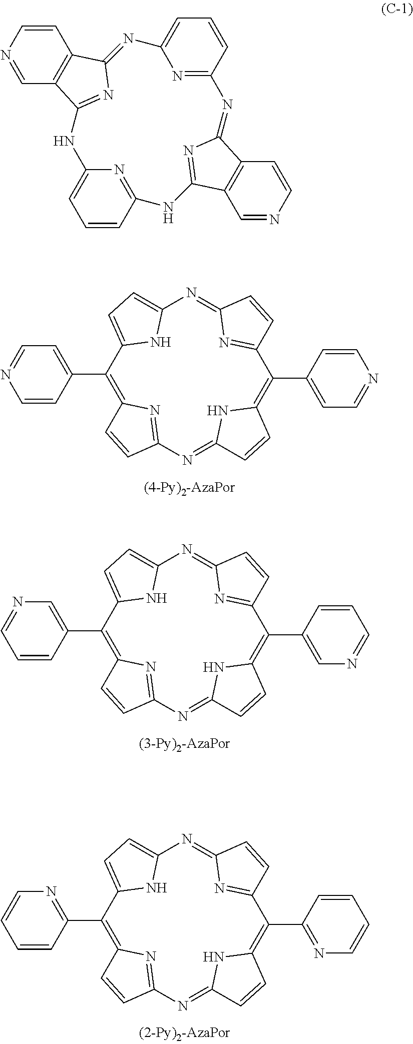 [SMILES: c1cc2nc3nc([nH]c4cccc(n4)[nH]c4nc(nc(c1)n2)-c1ccncc1-4)-c1cnccc1-3 ; C1=Cc2nc1nc1ccc([nH]1)c(-c1ccncc1)c1nc(nc3ccc([nH]3)c2-c2ccncc2)C=C1 ; C1=Cc2nc1nc1ccc([nH]1)c(-c1cccnc1)c1nc(nc3ccc([nH]3)c2-c2cccnc2)C=C1 ; C1=Cc2nc1nc1ccc([nH]1)c(-c1ccccn1)c1nc(nc3ccc([nH]3)c2-c2ccccn2)C=C1]

The nitrogen-containing compound described above preferably forms a crystal structure based on two or more bonds or interaction selected from π-π interaction, coordinate bond, charge transfer interaction and hydrogen bond. This is because, by using a low-molecular compound forming a crystal structure, the nitrogen-containing compound will be enhanced in the inter-molecular interaction, and will be suppressed from vaporizing during sintering for obtaining the nitrogen-containing carbon alloy.

The crystal structure in this context is referred to the style of arrangement or disposition of molecules in crystal. In other words, the crystal structure is composed of a repetitive structure of unit lattices, wherein the molecules are positioned, and thereby oriented, at arbitrary sites in the unit cell. The molecules have a uniform existing form in the crystal. In other words, since the functional groups are uniformly positioned in the crystal, the same inter-molecular interaction is established inside and outside of the unit cell. For example, in the nitrogen-containing compound having a stacked structure, interactions can occur among aromatic rings, heterocycles, fused polycycles, fused heteropolycycles, or unsaturated groups (nitrile groups, vinyl group, allyl groups, acetylene groups) [for example, π-π interaction (π-π stack) which occurs between the aromatic rings arranged face-to-face]. By such ordered inter-molecular stacking, at regular intervals, of the carbon SP² orbitals or the SP orbitals attributable to the unsaturated bonds in these rings or groups, the nitrogen-containing compound forms a stacked columnar structure.

In the stacked columnar structure, the adjacent stacked columns are regularly spaced by the inter-molecular distance attributable to hydrogen bond or Van der Waals interaction, to give a uniform structure. This creates an effect of facilitating heat conduction within the crystal.

The nitrogen-containing compound used this invention preferably has crystallinity. With the crystallinity, the nitrogen-containing compound becomes controllable in the orientation during the sintering, and can advantageously give a uniform carbon material.

The nitrogen-containing compound preferably has a melting point of 25° C. or higher. If the melting point is lower than 25° C., the nitrogen-containing compound, having no air layer contributive to heat resistance during the sintering, will unfortunately boil or bump during the sintering for a reason of relation between temperature and vapor pressure, and will fail to obtain the carbon material.

The nitrogen-containing compound preferably has a molecular weight of 60 to 2000, more preferably 100 to 1500, and particularly 130 to 1000. With the molecular weight controlled in these ranges, purification before the sintering will become easier.

A single species of the nitrogen-containing compound may be used, or two or species may be used in combination. The content of metal in the nitrogen-containing compound, other than the inorganic metal salt described later, is preferably 10 ppm by mass or less.

The nitrogen content of the nitrogen-containing compound is preferably 0.1% by mass to 55% by mass, more preferably 1% by mass to 30% by mass, and particularly 4% by mass to 20% by mass. By using the compound containing nitrogen atoms (N) within the above-described ranges, nitrogen atoms and metal can align uniformly and orderly on the crystal edge, without additionally introducing a nitrogen-source compound, so that nitrogen and metal become more likely to interact. Accordingly, the compositional ratio of nitrogen atom and metal may be the one capable of further enhancing the oxygen reduction reaction activity.

The nitrogen-containing compound is preferably a refractory compound having a ΔTG under a nitrogen atmosphere at 400° C. of −95% to −0.1%. The ΔTG of the nitrogen-containing compound is more preferably −95% to −1%, and particularly −90% to −5%. The nitrogen-containing compound is preferably a refractory compound which carbonizes by sintering without causing vaporization.

Now, ΔTG means a ratio of mass reduction at 400° C. of a mixture of the nitrogen-containing compound and the inorganic metal salt, relative to the mass at room temperature (30° C.), measured by TG-DTA by heating the mixture under a nitrogen flow of 100 mL/min, and under heating from 30° C. up to 1000° C. at a heating rate of 10° C./min.

The nitrogen-containing compound is also preferably a pigment having the structure represented by the formula (1).

The pigment can form a stacked columnar structure based on the inter-molecular π-π interaction, in which the stacked columns are regularly spaced by the inter-molecular distance attributable to hydrogen bond or Van der Waals interaction. This creates an effect of facilitating heat conduction within the crystal. Such high crystallinity enables relaxation of lattice vibration through phonon (quantized lattice vibration) under heating, and can give a high heat resistance. Accordingly the decomposition temperature can be raised up to the carbonization temperature, and this enables carbonization while suppressing vaporization of decomposition products.

Preferable examples include isoindoline-base pigment, isoindolinone-base pigment, diketopyrrolopyrrole-base pigment, quinacridone-base pigment, oxazine-base pigment, phthalocyanine-base pigment, quinophthalone-base pigment, latent pigment obtained by latent-treating pigment any of these pigments, and rake pigment obtained by insolubilizing dye with metal ion; wherein more preferable examples include diketopyrrolopyrrole-base pigment, quinacridone-base pigment, isoindoline-base pigment, isoindolinone-base pigment, quinophthalone-base pigment, and latent pigment (described later) obtained by solubilizing any of these pigments. This is because, when any of these pigments is sintered, a benzonitrile (Ph-CN) skeleton produced by decomposition can serve as an active reaction species, and thereby a carbon alloy catalyst with a higher oxygen reduction reaction activity may be produced. Coexistent metal species (M) can produce a complex in the form of Ph-CN . . . M, enabling production of a nitrogen-containing carbon alloy with a still higher oxygen reduction reaction activity.

### <Inorganic Metal Salt>

The inorganic metal salt is used for preparing the precursor. The inorganic metal salt may be hydroxide, oxide, nitride, sulfate, sulfite, sulfide, sulfonate, carbonylate, nitrate, nitrite, halide and so forth, without special limitation. They preferably has a halogen ion, nitrate ion or sulfate ion as a counter ion. Halide, nitrate, or sulfate, having a halogen ion, nitrate ion or sulfate ion respectively as a counter ion, can advantageously increase the specific surface area, since the carbon surface which appears in the process of thermal decomposition can be bound again with carbon.

In the method for manufacturing a nitrogen-containing carbon alloy of this invention, the inorganic metal salt is preferably a halide, wherein inorganic metal chloride is particularly preferable.

The inorganic metal salt may contain crystal water. The inorganic metal salt which contains crystal water will advantageously have an improved thermal conductivity, to thereby make the sintering uniform. The inorganic metal salt having crystal water, suitably used here, include cobalt(III) chloride hydrate, iron(III) chloride hydrate, cobalt(II) chloride hydrate, and iron(II) chloride hydrate.

Metal species of the inorganic metal salt is preferably at least one species of Fe, Co, Ni, Mn and Cr, and more preferably Fe or Co. Salts of Fe, Co, Ni, Mn and Cr successfully produce a nanometer-sized shell structure which can improve the catalytic activity of the carbon catalyst. Among them, Co and Fe are preferable since they successfully form the nano-sized shell structure. Co and Fe contained in the carbon catalyst can enhance therein the oxygen reduction reaction activity of the catalyst. The transition metal is most preferably Fe. A Fe-containing, nitrogen-containing carbon alloy shows a high rising potential, has a larger number of reactive electrons than Co, and is relatively increased in the durability of fuel cell. Note that one or more species of elements other than the transition metals [for example, B, alkali metals (Na, K, Cs), alkali earth metals (Mg, Ca, Ba), lead, tin, indium, thallium, etc.] may be contained, so long as the activity of the carbon catalyst is not interfered.

In this invention, the precursor preferably contains more than 5% by mass, relative to the total mass of the nitrogen-containing compound and the inorganic metal salt contained in the precursor (also mass of hydrated water included), of inorganic metal salt (the inorganic metal salt in this context include the mass of hydrated water). With this content, the nitrogen-containing carbon alloy with a still higher oxygen reduction reaction activity will be obtained as a result of interaction with nitrogen atom. By sintering an organic material containing the nitrogen-containing compound, the nitrogen-containing compound decomposes, and the decomposition product forms the nitrogen-containing carbon alloy catalyst in the gas phase. If any metal reside therearound in the gas phase during this process, the decomposition product interacts with the metal (forms a complex), to thereby further improve the performance of the nitrogen-containing carbon alloy. Moreover, it is preferable to form the nitrogen-containing carbon alloy having nitrogen atoms (N) immobilized over the surface of the carbon catalyst in a highly concentrated manner, by a catalytic action of a specific transition metal compound having been added to the nitrogen-containing compound which contains nitrogen atoms (N) as the constitutive element, and to form carbon particle which contains the transition metal compound interacted with the nitrogen atoms (N). Note that a part of the transition metal Compound interacted with the nitrogen atoms may be eliminated by acid rinsing.

In the method for manufacturing a nitrogen-containing carbon alloy of this invention, the precursor is preferably contained so that the content of the inorganic metal salt (in this context, the mass of hydrated water is included) exceeds 20% by mass, relative to the total mass of the nitrogen-containing compound and the inorganic metal salt contained in the precursor (the mass of hydrated water included), more preferably exceeds 20% by mass and does not exceed 85% by mass, and even more preferably exceeds 20% by mass and does not exceed 70% by mass.

Within these ranges, the carbon alloy having a higher oxygen reduction reaction activity (ORR value) may be produced.

The ORR value may be measured by a method detailed later in Example to determine current density, which will be assumed as ORR value. Lower values of current density during oxygen reduction reaction are more preferable to obtain higher output. More specifically, the current density is preferably −400 μA/cm² or smaller, more preferably −500 μA/cm² or smaller, even more preferably −600 μA/cm² or smaller, and most preferably −700 μA/cm² or smaller.

This invention is advantageous in that there is no need of uniformly dispersing the nitrogen-containing compound and the inorganic metal salt in the organic material (precursor) before the sintering. Since it is supposed that an active species which exhibits the oxygen reduction reaction activity may be formed, if only the decomposition product of sintering of the nitrogen-containing compound is brought into contact with a vaporized matter such as the inorganic metal salt, so that the oxygen reduction reaction activity of the nitrogen-containing carbon alloy is not affected by the state of mixing of nitrogen-containing compound and the inorganic metal salt at room temperature.

The inorganic metal salt preferably has a grain size of 0.001 to 100 μm in diameter, and more preferably 0.01 to 10 μm. With the grain size of the inorganic metal salt controlled in these ranges, it may be uniformly mixed with the nitrogen-containing compound, and thereby the nitrogen-containing compound when produced by decomposition will be more likely to form the complex.

### <Organometallic Complex>

In the method for manufacturing a nitrogen-containing carbon alloy of this invention, the precursor preferably contains at least one additional species of organometallic complex. By adding the organometallic complex to the precursor, the obtainable nitrogen-containing carbon alloy will have not only a high ORR value, but also a large number of reaction electrons.

The organometallic complex is exemplified by those described in “Sakutai Kagaku—Kiso to Saishin no Wadai (in Japanese, “Chemistry of Complex—Fundamentals and Latest Topics”), edited by the Society of Pure and Applied Coordination Chemistry, Kodansha Scientific Books (1994), and, more specifically, preferably exemplified by compounds having a metal ion and ligands coordinated therewith. The organometallic complex may have a variety of numbers of ligands, and the organometallic complex may include configurational isomers or each of the organometallic complex may have different ionic valences. The organometallic complex may be composed of organometallic compound having metal-carbon bond(s).

Preferable metal ions include those of Fe, Co, Ni, Mn and Cr.

Preferable ligands include monodentate ligand (halide ion, cyanate ion, ammonia, pyridine (py), triphenylphosphine, carboxylic acid, etc.); bidentate ligand [ethylenediamine (en), β-diketonato (acetylacetonato (acac), pivaloylmethane (DPM), diisobutoxymethane (DIBM), isobutoxypivaloylmethane (IBPM), tetramethyloctanedione (TMOD)), trifluoroacetylacetonato (TFA), bipyridine (bpy), phenanthrene (phen), etc.]; and multidentate ligand (ethylenediamine tetraacetate ion (edta), etc.).

The above-described metal complex usable here is exemplified by β-diketone metal complex (bis(acetylacetonato)iron(II) [Fe(acac)₂], tris(acetylacetonato)iron(III) [Fe(acac)₃], bis(acetylacetonato)cobalt(II) [Co(acac)₂], tris(acetylacetonato)cobalt(III) [Co(acac)₃], tris(dipivaloylmethane)iron(III) [Fe(DPM)₃], tris(dipivaloylmethane)cobalt(III) [Co(DPM)₃], tris(diisobutoxymethane)iron(III) [Fe(DIBM)₃], tris(diisobutoxymethane)cobalt(III) [Co(DIBM)₃], tris(isobutoxypivaloylmethane)cobalt(III) [Co(IBPM)₃], tris(tetramethyloctadione)iron(III) [Fe(TMOD)₃], tris(tetramethyloctadione)cobalt(III) [Co(TMOD)₃]), tris(1,10-phenanthroline)iron(III) chloride [Fe(phen)₃]Cl₂, tris(1,10-phenanthroline)cobalt(III) chloride [Co(phen)₃]Cl₂, N,N′-ethylenediamine bis(salicylideneaminato)iron(II) [Fe(salen)], N,N′-ethylenediamine bis(salicylideneaminato)cobalt(II) [Co(salen)], tris(2,2′-bipyridine)iron(II) chloride [Fe(bpy)₃]Cl₂, tris(2,2′-bipyridine)cobalt(II) chloride [Co(bpy)₃]Cl₂, metal phthalocyanine (MPc), iron acetate [Fe(OAc)₂], and iron acetate [Fe(OAc)₂]. Among them, preferable examples include β-diketonato iron complex (bis(acetylacetonato)iron(II) [Fe(acac)₂], tris(acetylacetonato)iron(III) [Fe(acac)₃], bis(dipivaloylmethane)iron(II) [Fe(DPM)₂], bis(diisobutoxymethane)iron(II) [Fe(DIBM)₂], bis(isobutoxypivaloylmethane)iron(II) [Fe(IBPM)₂], bis(tetramethyloctadione)iron(II) [Fe(TMOD)₂]), N,N′-ethylenediamine bis(salicylideneaminato)iron(II) [Fe(salen)], tris(2,2′-bipyridine)iron(II) chloride [Fe(bpy)₃]Cl₂, iron phthalocyanine (MPc), iron acetate [Fe(OAc)₂] and bis(acetylacetonato)iron(II) [Fe(acac)₂]. In the method for manufacturing a nitrogen-containing carbon alloy of this invention, it is particularly preferable to use β-diketonato iron(II) complex as the organometallic complex, which is exemplified by as iron(II) acetylacetonate, bis(dipivaloylmethane)iron(II) [Fe(DPM)₂], bis(diisobutoxymethane)iron(II) [Fe(DIBM)₂], bis(isobutoxypivaloylmethane)iron(II) [Fe(IBPM)₂], and bis(tetramethyloctadione)iron(II) [Fe(TMOD)₂]. Bis(acetylacetonato)iron(II) [Fe(acac)₂] is most preferable.

### (β-Diketone Metal Complex)

The organometallic complex preferably contains a β-diketone metal complex. As the organometallic complex, the β-diketone metal complex may be used alone, or the β-diketone metal complex may be used by mixing it with other organometallic complex. The β-diketone metal complex is a compound represented by the formula (7) below, and tautomers thereof.

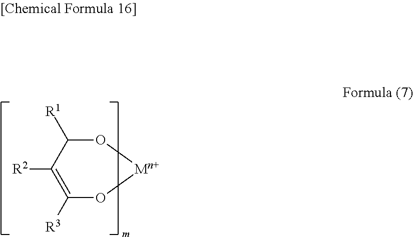

In the formula (7), M represents a metal, each of R¹ and R³ independently represents an optionally-substituted hydrocarbon group, and R² represents a hydrogen atom or optionally-substituted hydrocarbon group. Each of R¹, R² and R³ may be bound to each other to form a ring. n represents an integer of 0 or larger, and m represents an integer of 1 or larger.

In this compound, β-diketone or ion(s) thereof coordinate or bind to an atom or ion of metal M.

Metal M is preferably exemplified by Fe, Co, Ni, Mn and Cr, more preferably by Fe, Co, and even more preferably by Fe.

The “hydrocarbon group” in the optionally-substituted hydrocarbon group represented by each of R¹, R² and R³ is exemplified by aliphatic hydrocarbon group, alicyclic hydrocarbon group, aromatic hydrocarbon group, heterocyclic (heterocyclic) hydrocarbon group, and group formed by combining a plurality of them. The aliphatic hydrocarbon group is exemplified by alkyl groups (alkyl groups having 1 to 6 carbon atoms, etc.) such as methyl, ethyl, propyl, isopropyl, butyl, isobutyl, s-butyl, t-butyl and hexyl groups; and alkenyl groups (alkenyl group having 2 to 6 carbon atoms, etc.) such as allyl group. The alicyclic hydrocarbon group is exemplified by cycloalkyl groups (3 to 15-membered cycloalkyl groups, etc.) such as cyclopentyl and cyclohexyl groups; cycloalkenyl groups (3 to 15-membered cycloalkenyl groups, etc.) such as cyclohexenyl group; and bridged carbon cyclic group (bridged carbon cyclic group having approximately 6 to 20 carbon atoms, etc.) such as adamantyl group. The aromatic hydrocarbon group is exemplified by those having approximately 6 to 20 carbon atoms such as phenyl group and naphthyl group. The heterocyclic hydrocarbon group is exemplified by nitrogen-containing five-membered hydrocarbon groups such as pyrrolyl group, imidazolyl group and pyrazolyl group; nitrogen-containing six-membered hydrocarbon groups such as pyridyl group, pyrazinyl group, pyrimidinyl group, and pyridazinyl group; nitrogen-containing fused bicyclic hydrocarbon groups such as pyrrolidinyl group, indolidinyl group, isoindolyl group, isoindolinyl group, indolyl group, indazolyl group, purinyl group, quinolidinyl group, quinolinyl group, naphthylidinyl group, phthalazinyl group, quinoxalinyl, cinnolinyl group, and pteridinyl group; nitrogen-containing fused tricyclic hydrocarbon groups such as carbazolyl group, β-carbonyl group, phenanthridinyl group, acridinyl group, perimidinyl group, phenanthrolinyl group, phenazinyl group, and anthyridinyl group; and hydrocarbon groups of oxygen-containing monocyclic type, oxygen-containing polycyclic type, sulfur-containing type, and selenium/tellurium-containing cyclic type.

The substituent which may be possessed by the hydrocarbon group is exemplified by halogen atoms such as fluorine, chlorine and bromine atoms; alkoxy groups (alkoxy group having 1 to 4 carbon atoms, etc.) such as methoxy, ethoxy, propoxy, isopropyloxy, butoxy, isobutyloxy, and t-butyloxy groups; hydroxy group; alkoxycarbonyl group (alkoxycarbonyl group having 1 to 4 carbon atoms, etc.) such as methoxycarbonyl, and ethoxycarbonyl groups; acyl group (acyl group having 1 to 10 carbon atoms, etc.) such as acetyl, propionyl, and benzoyl groups; cyano group; and nitro group.

The ring which may be formed by R¹, R² and R³ bound to each other is exemplified by 5 to 15-membered cycloalkane ring and cycloalkene ring, such as cyclopentane ring, cyclopentene ring, cyclohexane ring, and cyclohexene ring.

Each of R¹ and R³ preferably represents an alkyl group (alkyl group having 1 to 6 carbon atoms, etc.), alkenyl group (alkenyl group having 2 to 6 carbon atoms, etc.), cycloalkyl group (3 to 15-membered cycloalkyl group, etc.), cycloalkenyl group (3 to 15-membered cycloalkenyl group, etc.), aryl group (aryl group having 6 to 15 carbon atoms, etc.), or substituted aryl group (aryl group having 6 to 15 carbon atoms, having a substituent such as p-methylphenyl group, p-hydroxyphenyl group or the like). R² preferably represents a hydrogen atom, alkyl group (alkyl group having 1 to 6 carbon atoms, etc.), alkenyl group (alkenyl group having 2 to 6 carbon atoms, etc.), cycloalkyl group (3 to 15-membered cycloalkyl group, etc.), cycloalkenyl group (3 to 15-membered cycloalkenyl group, etc.), aryl group (aryl group having 6 to 15 carbon atoms, etc.), and substituted aryl group (aryl group having 6 to 15 carbon atoms, having a substituent such as p-methyl phenyl group, p-hydroxyphenyl group or the like).

In the compound represented by the formula (7), the metal may have a valence n of 0, 1, 2, or 3, which is generally 2 or 3. When the metal is divalent or trivalent, the β-diketone coordinates in the form of β-diketonato which is a correspondent anion. Assuming the valence of metal as n, the coordination number m generally has an equal value. The metal may be axially coordinated by solvent or the like, wherein the valence n and the coordination number m in this case may be different.

The solvent capable of axial coordination is exemplified by pyridine, acetonitrile and alcohol, but may be anything so long as it can axially coordinate.

The β-diketone iron complex may be a commercially available product used without modification or after purified, or may be a prepared product. The β-diketone iron complex may alternatively be used in situ in a production system where it is produced. When it is produced in the reaction system, for example, a chloride or hydroxide of iron, and a β-diketone such as acetylacetone may be added. In this process, it is optionally possible to add a base such as ammonia; amines; and hydroxide, carbonate or carboxylate of alkali metal or alkali earth metal.

The amount of addition of β-diketone iron complex is generally 0.001 to 50 mol %, preferably 0.01 to 10 mol %, and particularly 0.1 to 1 mol % or around.

### (Conduction Aid)

In this invention, a conduction aid may be added to the precursor when it is sintered, or may be added to the nitrogen-containing carbon alloy. For uniform dispersion of the conduction aid, the conduction aid is more preferably added in the process of sintering.

The conduction aid is exemplified by, but not specifically limited to, carbon black or graphite under trade names of Norit (from NORIT), Ketjen black (from LION Corporation), Vulcan (from Cabot Corporation), Black Pearls (from Cabot Corporation), and acetylene black (from Chevron); and carbon materials such as C60 and C70 fullerenes, carbon nanotube, carbon nanohorn, and carbon fiber.

The amount of addition of conduction aid is preferably 0.01% by mass to 50% by mass relative to the total mass of the precursor, more preferably 0.1% by mass to 20% by mass, and even more preferably 1% by mass to 10% by mass. If the conduction is added too much, the metal produced from the inorganic metal salt in the system will aggregate and grow non-uniformly, so that unfortunately a target porous nitrogen-containing carbon will not be obtained.

### (2) Temperature Elevating Step and (3) Carbonization Step

In the manufacturing method of this invention, it is preferable to anneal the precursor, which contains the nitrogen-containing compound having a specific structure and the inorganic metal salt, up to the carbonization temperature.

In the annealing up to the carbonization temperature, processes which involve temperature elevation will collectively be referred to as infusibilization.

While the sintering temperature in the carbonization is not specifically limited, so long as the nitrogen-containing compound can decompose and carbonize under such temperature, it is preferably 400° C. or above, more preferably 500° C. or above, and even more preferably 600° C. or above. By controlling the sintering temperature at 400° C. or above, the obtainable nitrogen-containing carbon alloy will have a sufficient degree of carbonization to ensure a high catalytic activity. The sintering temperature is preferably 1000° C. at the highest. By controlling the sintering temperature at 1000° C. or lower, nitrogen can remain in the carbon skeleton to give a desired atomic ratio (N/C), and thereby a sufficient level of oxygen reduction reaction activity may be obtained.

For the case where the manufacturing method of this invention includes the later-described, re-sintering step which is allowed to proceed at higher temperature than in the initial carbonization, the sintering temperature for carbonization preferably falls in the range from 400 to 900° C., more preferably from 500 to 850° C., and even more preferably from 600 to 800° C.

In the carbonization, a material to be processed is kept preferably at 400° C. to 1000° C., for 0.1 hours to 100 hours, and more preferably for one hour to 10 hours. The carbonization, even if extended beyond 10 hours, will not always give an effect matched to the length of time.

The carbonization is preferably allowed to proceed under an inert gas atmosphere, and preferably under a flow of inert gas or non-oxidizing gas. The flow rate of the gas is preferably 0.01 to 2.0 liters/min per 36 mm of inner diameter, more preferably 0.05 to 1.0 liters/min per 36 mm of inner diameter, and particularly 0.1 to 0.5 liters/min per 36 mm of inner diameter. By allowing the carbonization to proceed under a flow rate of gas of 0.01 liters/min or more per 36 mm of inner diameter, amorphous carbon which is by-produced during the sintering may be distilled off, and thereby the process temperature of the nitrogen-containing carbon alloy may be suppressed from lowering. By allowing the carbonization to proceed under a flow rate of gas of 2.0 liters/min or less per 36 mm of inner diameter, the base is prevented from vaporizing before being carbonized, and thereby the nitrogen-containing carbon alloy may be produced in an efficient manner. In short, by controlling the flow rate in these ranges, a target nitrogen-containing carbon alloy may be obtained in a suitable manner.

When the carbonization is allowed to proceed at a high temperature in a single-stage process, the yield of the nitrogen-containing carbon alloy would decrease, but the resultant nitrogen-containing carbon alloy will have a uniform crystallite size, so that the metal can distribute uniformly to keep the activity high. It consequently becomes possible to manufacture the nitrogen-containing carbon alloy with an excellent oxygen reduction reaction performance.

The temperature elevation in the temperature elevating step may be divided into two stages. More specifically, the first stage may be implemented at a relative low temperature, to thereby successfully remove heat-instable impurity, solvent and so forth.

The succeeding second stage may be implemented at a higher temperature than in the first stage. This not only allows the decomposition and carbonization of the organic materials to proceed in a consecutive manner, but also allows the decomposition product and the metal to interact, to thereby stabilize the metal in a state of higher activity. For example, iron ion may be kept in the divalent state. This enables manufacture of the nitrogen-containing carbon alloy with a high oxygen reduction reaction performance.

In addition, the second stage makes it possible to elevate the temperature in the succeeding carbonization, and to obtain the nitrogen-containing carbon alloy with a still higher regularity of the carbon structure. As a consequence, the nitrogen-containing carbon alloy will have an improved electro-conductivity, and a higher oxygen reduction reaction performance, proving an increased durability of the catalyst.

The temperature elevation up to the first-stage temperature is aimed at maintaining only a heat-stable structure, and preheating it in preparation for the second stage. The temperature elevation up to the carbonization temperature in the second stage is aimed at obtaining a suitable nitrogen-containing carbon alloy. In contrast, if the temperature exceeds the carbonization temperature, the carbonization will be excessive, and this occasionally makes it impossible to obtain a suitable nitrogen-containing carbon alloy, and degrades the yield.

The temperature elevation in the first stage is preferably allowed to proceed under an inert atmosphere. The inert atmosphere is referred to as a gaseous atmosphere which contains nitrogen gas, rare gas or the like. Even with some oxygen contained therein, the atmosphere is acceptable if the oxygen content is reduced enough to suppress combustion of the material to be processed. The atmosphere may be either a closed system, or a flow system allowing a fresh gas to flow therethrough, and is preferably a flow system. If configured to be the flow system, the flow rate of gas is preferably 0.01 to 2.0 liters/min per 36 mm of inner diameter, more preferably 0.05 to 1.0 liters/min per 36 mm of inner diameter, and even more preferably 0.1 to 0.5 liters/min per 36 mm of inner diameter.

In the temperature elevation in the first stage, the organic material which contains the nitrogen-containing compound, the inorganic metal salt and so forth, is preferably heated to 100° C. to 500° C., and more preferably to 150° C. to 400° C. In this way, a uniform preliminary carbide may be obtained.

The temperature elevation in the first stage, from normal temperature up to a predetermined temperature, may be conducted after the organic material (precursor) which contains the nitrogen-containing compound, the inorganic metal salt and so forth is placed in a carbonization apparatus or the like; or, the organic material may be placed for example in a carbonization apparatus or the like conditioned at a predetermined temperature. The temperature elevation in the first stage is preferably conducted so as to elevate the temperature from normal temperature up to a predetermined temperature. The temperature elevation from the normal temperature up to a predetermined temperature is preferably conducted at a constant rate of temperature elevation. More specifically, the rate of temperature elevation is 1° C./min or faster and 1000° C./rain or slower, and more preferably 1° C./min or faster and 500° C./min or slower.

The temperature elevation in the second stage may be conducted in succession to the temperature elevation in the first stage, so as to successively elevate the temperature. Alternatively, the temperature may be once brought down to room temperature, and then elevated again for the temperature elevation in the second stage. After the temperature elevation in the first stage, the preliminary carbide may be crushed uniformly, may be molded thereafter, or may be acid-rinsed to remove the metal. It is preferable to uniformly crush the preliminary carbide, followed by acid rinsing. More preferably, the rate of temperature elevation is preferably 2° C./rain or faster and 1000° C./min or slower, and more preferably 5° C./min or faster and 500° C./rain or slower.

The temperature elevation in the second stage is preferably conducted under an inert atmosphere, and when conducted in a flow system, the gas is preferably fed at a flow rate of 0.01 to 2.0 liters/min per 36 mm of inner diameter, more preferably 0.05 to 1.0 liters/min per 36 mm of inner diameter, and particularly 0.1 to 0.5 liters/min per 36 mm of inner diameter. The flow rate in the second stage may be different from the flow rate in the first stage.

The carbonization is preferably allowed to proceed in the presence of an activator. By the carbonization in the presence of activator at high temperatures, the nitrogen-containing carbon alloy will have pores well developed therein to increase the surface area, and will have a larger amount of metal exposed to the surface thereof, and is thereby increased in the catalytic performance. The surface area of the carbide may be measured based on the amount of N₂ adsorption.

The activator usable here is not specifically limited, and may be at least one species selected from carbon dioxide, steam, air, oxygen, alkali metal hydroxide, zinc chloride and phosphoric acid; and more preferably selected from carbon dioxide, steam, air and oxygen. A sufficient level of content of the gaseous activator, such as carbon dioxide or steam, in the carbonization atmosphere is 2 to 80 mol %, and preferably 10 to 60 mol %. A sufficient level of activation effect will be obtained by controlling the content to 2 mol % or above, whereas the activation effect will be excessive when the content exceeds 80 mol %, which may markedly reduce the yield of carbide, to thereby disable efficient manufacture of the carbide. The solid activator such as alkali metal hydroxide may be mixed in the form of solid with a material to be carbonized; or, may be dissolved or diluted with a solvent such as water, and allowed to impregnate into a material to be carbonized which is immersed therein; or, may be prepared in the form of slurry and kneaded into a material to be carbonized. The liquid activator may be impregnated into a material to be carbonized after diluted with water or the like, or may be kneaded into a material to be carbonized.

Nitrogen atoms may also be introduced after the carbonization. Method of introducing nitrogen atoms usable in this case include liquid phase doping, gas phase doping, and gas phase-liquid phase doping. For example, by keeping, for annealing, the nitrogen-containing carbon alloy under an atmosphere containing ammonia as a nitrogen source, at 200° C. or above and 800° C. or below, for 5 minutes or longer and 180 minutes or shorter, nitrogen atoms may be introduced to the surface of the carbon catalyst.

### (4) Cooling and (5) Crushing

The carbonization may be followed by cooling of the nitrogen-containing carbon alloy down to room temperature, and crushing. The crushing may follow any method known to those skilled in the art, and may be conducted typically by using a ball mill or by mechanical crushing.

### (6) Acid Rinsing

In the method for manufacturing a nitrogen-containing carbon alloy of this invention, the sintering step is preferably followed by an acid rinsing step, rinsing the sintered nitrogen-containing carbon alloy using an acid. By rinsing the sintered nitrogen-containing carbon alloy with an acid, metal exposed to the surface of the nitrogen-containing carbon alloy may be rinsed off with the acid, to thereby distinctively enhance the ORR activity of the nitrogen-containing carbon alloy. While not adhering to any theory, it is supposedly because that a porous nitrogen-containing carbon alloy having an optimum porosity was successfully obtained by the acid rinsing.

In the acid rinsing step, an arbitrary aqueous Brønsted (protonic) acid, including strong acid and weak acid, may be used. Inorganic acid (mineral acid) or organic acid may be used. Preferable examples of the acid include, but not limited to, HCl, HBr, HI, H₂SO₄, H₂SO₃, HNO₃, HClO₄, [HSO₄]⁻, [HSO₃]⁻, [H₃O]⁺, H₂[C₂O₄], HCO₂H HClO₃, HBrO₃, HBrO₄, HIO₃, HIO₄, FSO₃H, CF₃SO₃H, CF₃CO₂H, CH₃CO₂H, and B(OH)₃ (also including arbitrary combination of them).

A method described in JP-T2-2010-524195 may also be used in this invention.

### (7) Re-Sintering

In the method for manufacturing a nitrogen-containing carbon alloy of this invention, the acid rinsing step is preferably followed by re-sintering of the acid-rinsed, nitrogen-containing carbon alloy. By the re-sintering, an electrode coated with the nitrogen-containing carbon alloy may be improved in the current density as the amount of coating on the electrode increases, to thereby enhance the ORR value. Note that the conventional carbon alloy (for example, a carbon alloy described in JP-A-2011-225431, sintered at 700° C.), not having been rinsed with acid, is not so much improved in the current density, even if the amount of coating is increased.

The re-sintering is preferably carried out at a temperature higher than the carbonization temperature of the precursor. The upper limit of the sintering temperature in the re-sintering step is preferably 1000° C. or lower, for example. The lower limit of the sintering temperature is 500° C. or higher, more preferably 600° C. or higher, and even more preferably 700° C. or higher.

### [Nitrogen-Containing Carbon Alloy]

The nitrogen-containing carbon alloy of this invention is manufactured by the method for manufacturing a nitrogen-containing carbon alloy of this invention.

The nitrogen-containing carbon alloy of this invention obtained by sintering the precursor is a carbon alloy introduced with nitrogen. The nitrogen-containing carbon alloy of this invention preferably contain graphene, which is an assemblage of carbon atoms chemically bound with each other through sp² hybrid orbitals, to form a hexagonal mesh structure which spreads two-dimensionally.

In the nitrogen-containing carbon alloy of this invention, the content of surface nitrogen atom in the carbon catalyst is preferably 0.05 to 0.3 in terms of atomic ratio (N/C) relative to the surface carbon. With the atomic ratio of nitrogen atom and carbon atom (N/C) controlled to 0.05 or above, there will be a proper number of nitrogen atoms capable of binding the metal, thereby a sufficient level of catalytic performance of oxygen reduction reaction will be obtained. Meanwhile, with the atomic ratio of nitrogen atom and carbon atom (N/C) controlled to 0.3 or below, the nitrogen-containing carbon alloy will have a good strength of carbon skeleton and a good electro-conductivity.

The skeleton of the nitrogen-containing carbon alloy is good enough to contain at least carbon atoms and nitrogen atoms, and may also contain, as other atom, hydrogen atom, oxygen atom and so forth. In this case, the atomic ratio of such other atom, relative to carbon atom and nitrogen atom ((other atom)/(C+N)), is preferably 0.3 or smaller.

The specific surface area may be determined by the BET (Brunauer-Emmett-Teller) method, by which the nitrogen-containing carbon alloy is placed in a predetermined container, cooled to the liquid nitrogen temperature (−196° C.), nitrogen gas is then introduced into the container for adsorption, the monolayer adsorbed gas quantity and an adsorption parameter are calculated based on the adsorption isotherm, and the specific surface area of the sample is determined using the adsorption cross section of nitrogen (0.162 cm²).

The pore geometry of the nitrogen-containing carbon alloy is not specifically limited. For example, the pores may be formed only in the surficial portion, or not only in the surficial portion but also deep inside. The pores, if formed deep inside, may penetrate the nitrogen-containing carbon alloy like a tunnel, or may have a geometry such that spherical, hexagonal pillar-shaped, or other polygonal pillar-shaped pores communicate with each other.

The nitrogen-containing carbon alloy preferably has a specific surface area of 90 m²/g or larger, more preferably 350 m²/g or larger, and particularly 670 m²/g or larger. Note, however, that the above-described ranges do not always apply to the case where active sites of the catalyst (metal coordinated product composed of at least C, N and a metal ion, or coordination space (field)) are formed or produced in a highly concentrated manner.

From the viewpoint of allowing a sufficient amount of oxygen to reach deep into the pores to ensure a sufficient level of catalytic performance for oxygen reduction reaction, the nitrogen-containing carbon alloy preferably has a specific surface area of 3000 m²/g or smaller, more preferably 2000 m²/g or smaller, and particularly 1300 m²/g or smaller.

The shape of the nitrogen-containing carbon alloy of this invention is not specifically limited so long as it can exhibit the oxygen reduction reaction reactivity. The shape is exemplified by sheet, fiber, block, column, grain, and various shapes largely deformed from sphere such as ellipsoids, oblate sphere and angular sphere. From the viewpoint of easy dispersion, the shape is preferably block or grain.

Moreover, the nitrogen-containing carbon alloy of this invention may be dispersed into a solvent, to prepare a slurry which contains the nitrogen-containing carbon alloy. With this slurry, it now becomes possible to facilitate manufacture of, for example, an electrode catalyst for fuel cells or an electrode material for power storage devices, wherein an arbitrarily shaped carbon catalyst may be formed on a support by coating the slurry, having the nitrogen-containing carbon alloy dispersed in the solvent, followed by sintering and drying. By making the nitrogen-containing carbon alloy into the slurry, the carbon catalyst will more easily be processed, and will more easily be used as the electrode catalyst or electrode material.

In the fuel cell catalyst of this invention, the amount of coating, after dried, of the nitrogen-containing carbon alloy is preferably 0.01 mg/cm² or more, more preferably 0.02 to 100 mg/cm² or more, and particularly 0.05 to 10 mg/cm².

The solvent used here is suitably selectable from those used for manufacturing the electrode catalyst for fuel cells or the electrode material for power storage devices. Examples of the solvent used for manufacturing the electrode material for power storage devices include general polar solvents such as diethyl carbonate (DEC), dimethyl carbonate (DMC), 1,2-dimethoxyethane (DME), ethylene carbonate (EC), ethyl methyl carbonate (EMC), N-methyl-2-pyrrolidone (NMP), propylene carbonate (PC), and γ-butyrolactone (GBL), each of which may be used independently, or two or more species of them may be mixed. Meanwhile, examples of the solvent used for manufacturing the electrode catalyst for fuel cells include water, methanol, ethanol, isopropanol, butanol, toluene, xylene, methyl ethyl ketone, and acetone.

### <Applications of Nitrogen-Containing Carbon Alloy>

While the nitrogen-containing carbon alloy of this invention is applicable to structural material, electrode material, filter material, and catalyst material without special limitation, it is preferably applicable to the electrode material for power storage devices such as capacitor and lithium secondary battery; more preferably applicable to the carbon catalysts for fuel cell, zinc-air battery and lithium-air battery which are characterized for their high oxygen reduction activity; and particularly applicable to the fuel cell catalyst. The fuel cell catalyst is typically used for a catalyst layer in a membrane-electrode assembly which has a solid polymer electrolyte membrane, and such catalyst layer provided in contact with the solid polymer electrolyte membrane. The membrane-electrode assembly may further be provided to the fuel cell.

### (Fuel Cell)

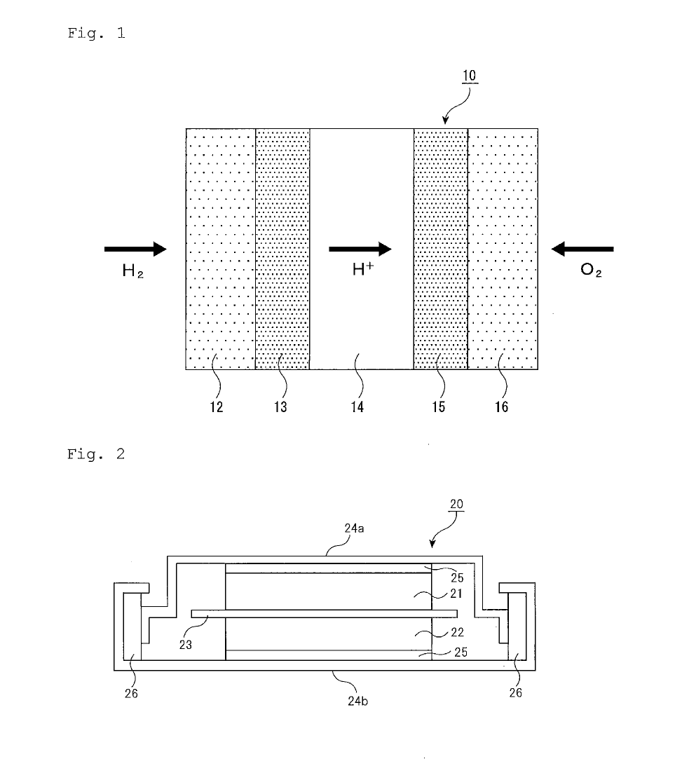

A schematic configuration diagram of a fuel cell, using a carbon catalyst composed of the nitrogen-containing carbon alloy of this invention, is shown in FIG. 1. The carbon catalyst is applied to an anode and a cathode.

A fuel cell 10 is composed of a separator 12, an anode catalyst (fuel electrode) 13, a cathode catalyst (oxidizer electrode) 15 and a separator 16, which are opposingly disposed while placing a solid polymer electrolyte 14 in between. As the solid polymer electrolyte 14, a fluorine-containing cation exchange resin film represented by perfluorosulfonate resin film is used. By providing the carbon catalyst in the form of the anode catalyst 13 and the cathode catalyst 15 in contact with both sides of the solid polymer electrolyte 14, configured now is the fuel cell 10 which uses the carbon catalyst for the anode catalyst 13 and the cathode catalyst 15. The carbon catalyst is formed on both surfaces of the solid polymer electrolyte, and the anode catalyst 13 and the cathode catalyst 15 are tightly adhered, on the electrode reaction layer side thereof, onto both principal surfaces of the solid polymer electrolyte 14 by hot pressing, to thereby give an integrated MEA (Membrane Electrode Assembly).

In the conventional fuel cell, a gas diffusion layer composed of a porous sheet (for example, carbon paper), also capable of serving as a current collector, has been interposed between each separator and anode or cathode catalyst. In contrast, in the fuel cell 10 illustrated in FIG. 1, the carbon catalyst having a large specific surface area, and a high gas diffusibility may be used as the anode and cathode catalysts. By using, as the electrodes, the above-described carbon catalyst which is assumed to also act as a gas diffusion layer, it now becomes possible, even if there is no dedicated gas diffusion layer, to configure the fuel cell in which the anode and cathode catalysts 13, 15 are functionalized to be the gas diffusion layer, so that the fuel cell may be downsized and reduced in cost through omission of the gas diffusion layer.

The separators 12, 16 take part in supporting the anode and cathode catalyst layers 13, 15, and in feeding and discharging of reaction gases such as H₂ as the fuel gas and O₂ as the oxidizer gas. Upon feeding of the reaction gases respectively to the anode and cathode catalysts 13, 15, a three phase boundary participated by the gas phase (reaction gases), the liquid phase (solid polymer electrolyte membrane), and the solid phase (catalyst held by both electrodes) is formed at the boundary between the carbon catalyst possessed by both electrodes and the solid polymer electrolyte 14, where DC current generates by electrochemical reactions.

The electrochemical reactions include:

cathode side: O₂+4H⁺+4e^{-→}2H₂O

anode side: H₂→2H⁺+2e⁻

where, H⁺ ions produced on the anode side migrate through the solid polymer electrolyte 14 towards the cathode, and e⁻ (electrons) migrate through an external load again towards the cathode. Meanwhile, on the cathode side, oxygen contained in the oxidizer gas, and H⁺ ions and e⁻ migrated from the anode side combine to produce water. The fuel cell eventually generates DC current by reacting hydrogen and oxygen.

### (Power Storage Device)

Next paragraphs will describe a power storage device which uses the carbon catalyst, composed of the nitrogen-containing carbon alloy of this invention is applied to the electrode material. FIG. 2 is a schematic configuration diagram illustrating a large-capacity electric double-layer capacitor 20 using the carbon catalyst.

In the electric double-layer capacitor 20 illustrated in FIG. 2, a first electrode 21 and a second electrode 22, which are polarizing electrodes, are opposed while placing a separator 23 in between, and are then collectively housed in an outer package lid 24a and an outer package case 24b. The first electrode 21 and the second electrode 22 are connected, through the current collectors 25, to the outer package lid 24a and the outer package case 24b, respectively. The separator 23 is impregnated with an electrolyte solution. The outer package lid 24a and the outer package case 24b are caulked and sealed, while placing a gasket 26 in between to electrically isolate them, to configure the electric double-layer capacitor 20.

In the electric double-layer capacitor 20 illustrated in FIG. 2, the above-described carbon catalyst is applicable to the first electrode 21 and the second electrode 22. Thus successfully provided is an electric double-layer capacitor in which the carbon catalyst is applied to the electrode material. The above-described carbon catalyst has a fibrous structure formed by an assembly of nanoshell carbon, wherein the diameter of fiber is on the nanometer level, and therefore has a large specific surface area, and can give a large electrode interface where the electric charge accumulates in the capacitor. Moreover, the carbon catalyst is electrochemically inert against the electrolytic solution, and has a suitable level of electroconductivity. Accordingly, use of the carbon catalyst as the capacitor electrodes successfully improves the electrostatic capacity per unit area of the electrodes.

Similarly to the case with the above-described capacitor, and, just like the anode material of lithium ion secondary battery, the carbon catalyst is also used as an electrode material composed of carbon material. By virtue of a large specific surface area of the carbon catalyst, a large-capacity secondary battery is thus configured.

### (Environmental Catalyst)

The next paragraphs will explain an exemplary case where the nitrogen-containing carbon alloy of this invention is used as a substitute for environmental catalysts which contain platinum or other noble metals.

Environmental catalysts, configured solely by platinum or other noble metal-base material, or by combining it with other materials, have been used as catalysts for purifying emission gas, aimed at decompositionally remove pollutant (mainly gaseous substance) contained in polluted air. The carbon catalyst may be used as a substitute for the catalysts for emission gas purification which contains platinum or other noble metals. The carbon catalyst, given a catalytic action for oxygen reduction reaction, can function to decompose substances to be processed such as pollutant. Accordingly, by configuring the environmental catalyst using the carbon catalyst, it is no longer necessary to use platinum or other expensive noble metals, and thereby an inexpensive environmental catalyst may be provided. The large specific surface area will contribute to expand, per unit volume, an area over which the substance to be processed is decomposed, thereby the environmental catalyst with an excellent decomposition ability per unit volume may be configured.

It is further possible to configure the environmental catalyst with a still higher catalytic action such as decomposition ability, by using the carbon catalyst as a carrier, to which platinum or other noble metals, having been used for the conventional environmental catalysts, is immobilized. The environmental catalyst provided with the carbon catalyst may be used not only as a catalyst for emission gas purification described above, but also as a purification catalyst for water purification.

The nitrogen-containing carbon alloy of this invention may widely be used as catalysts for chemical reactions, and especially as a substitute for platinum catalyst. In other words, the carbon catalyst may be used as a substitute for process catalyst containing platinum or other noble metals for general industrial use. Accordingly, by using the carbon catalyst, it now becomes possible to provide inexpensive process catalysts for chemical reactions, without using any expensive noble metals such as platinum. The carbon catalyst can also configure process catalysts with a high efficiency of chemical reaction per unit volume, by virtue of its large specific surface area.

This sort of carbon catalyst for chemical reaction is applicable, for example, to hydrogenation catalyst, dehydrogenation catalyst, oxidation catalyst, polymerization catalyst, reforming catalyst, and steam reforming catalyst. More specifically, the carbon catalyst is applicable to respective chemical reactions referring to catalyst-related literatures such as “Shokubai Chosei (in Japanese, “Preparation of Catalyst”), co-written by Takayasu SHIRASAKI and Naoyuki TODO (published by Kodansha Ltd.), 1975”.

### EXAMPLE

This invention will further be detailed below referring to Examples. Materials, amounts of consumption, ratios, details of processes, and procedures of processes described in Examples below may be modified suitably, without departing from the spirit of this invention. The scope of this invention is therefore by no means interpreted limitatively by Examples described below. Also note that “part(s)” is based on mass, unless otherwise specifically noted.

### <Method of Evaluating Physical Properties of Nitrogen-Containing Carbon Alloy>

### (Measurement of Specific Surface Area by BET Method)

A sample of the nitrogen-containing carbon alloy before acid rinsing, and a sample of nitrogen-containing carbon alloy isolated after acid rinsing were dried in vacuo at 200° C. for 3 hours, using a sample pretreatment apparatus (BELPREP-flow (trade name) from BEL Japan, Inc.).

The specific surface area of the nitrogen-containing carbon alloy was then measured under simplified conditions for measurement, using an automatic specific surface area/pore size distribution analyzer (BELSORP-mini II (trade name), from BEL Japan, Inc.).

The specific surface area was determined by the BET (Brunauer-Emmett-Teller) method using a pre-installed analytical program.

### Example 1

### Synthesis of Carbon Material Composed of Iron(II) Chloride Tetrahydrate-Added (4-Py)₄-Por (1C)

### (Preparation of (4-Py)₄-Por Mixture)

(4-Py)₄-Por was prepared referring to Chemistry Letters, 2007, 36, 848-849.

To 0.4 liters of xylene, 6.4 g of 4-pyridylaldehyde (from Wako Pure Chemical Industries, Ltd.) and 4.0 g of 2-hydroxybenzoic acid (from Wako Pure Chemical Industries, Ltd.) were added, the mixture was refluxed under heating, and a solution obtained by dissolving 4.0 g of pyrrole (from Kanto Chemical Co., Inc.) into 0.1 liters of xylene was added dropwise over one hour. The mixture was refluxed under heating under a nitrogen gas flow for 3 hours, and xylene was then distilled off under reduced pressure. The residual solid was rinsed under heating using 0.3 liters of ethyl acetate and 0.03 liters of methanol, and then collected by filtration, which were repeated twice, to thereby obtain 3.95 g of (4-Py)₄-Por (ultramarine powder).

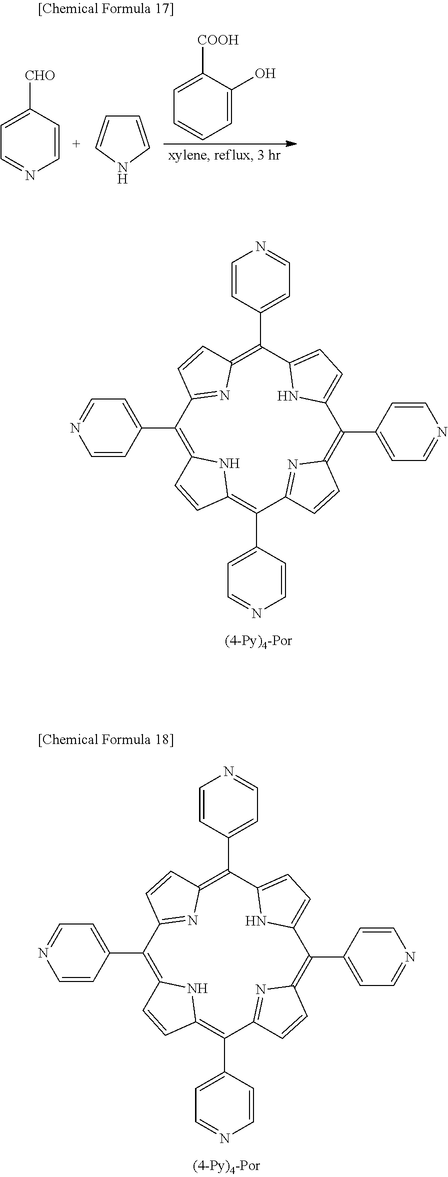

Molecular formula: C₄₀H₂₆N₈, Molecular weight: 618.69

Elemental analysis (calculated value): C, 77.65; H, 4.24; N, 18.11

### (Preparation of Iron(II) Chloride Tetrahydrate-Added (4-Py)₄-Por Mixture)

Iron(II) chloride tetrahydrate-added (4-Py)₄-Por mixture (1A) was obtained, by adding 4.15 g of the above-described (4-Py)₄-Por and 4.15 g of iron(II) chloride tetrahydrate, followed by mechanical crushing and mixing.

### (Infusibilization and Carbonization)

On a quartz boat, 2.0936 g of iron(II) chloride tetrahydrate-added (4-Py)₄-Por mixture (1A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 1.0163 g of carbon material (1B).

### (Crushing, Acid Rinsing, and Measurement of Specific Surface Area)

Carbon material (1B) was crushed in an agate mortar, to obtain a non-acid-rinsed carbon material. The specific surface area of the thus obtained non-acid-rinsed carbon material was measured by the BET method, and result was given in the “Before acid rinsing” column in Table 1 below.

The non-acid-rinsed carbon material carbon material (1B) obtained after crushing in the agate mortar was subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (1C). The thus obtained acid-rinsed carbon material (1C) was denoted as the nitrogen-containing carbon alloy of Example 1. The specific surface area thereof was measured by the BET method. The result was shown in the “After acid rinsing” column in Table 1 below.

### 1. Oxygen Reduction Reaction (ORR) of Carbon Alloy-Coated Electrode

### (Manufactured of Carbon Alloy-Coated Electrode)

To 10 mg of the thus obtained nitrogen-containing carbon alloy of Example 1, added were 110 mg of Nafion solution (5% aqueous alcohol solution) as a binder, and 2.4 mL of water and 1.6 mL of 1-propanol (IPA) as solvents, and the mixture was dispersed for 30 minutes using an ultrasonic homogenizer (from Nissei Ltd., US-150T (trade name)) with a 7-mm-diameter attachment. Using a rotary ring disc electrode (HR2-RD1-Pt8/GC5 (trade name), from Hokuto Denko Corp.), the nitrogen-containing carbon alloy dispersion liquid was coated over the carbon electrode, so as to control the amount of coating of the nitrogen-containing carbon alloy to 0.05 mg/cm², and then dried at room temperature to obtain a carbon alloy-coated electrode.

### (Measurement of Oxygen Reduction Reaction (ORR) of Carbon Alloy-Coated Electrode)

A rotary electrode device (from Hokuto Denko Corp., HR-201 (trade name)) was connected to an automatic polarization system (from Hokuto Denko Corp., HZ-3000 (trade name)), and the measurement was conducted according to the procedures below, using the above obtained carbon alloy coated electrode as the working electrode, and a platinum electrode and a saturated calomel electrode (SCE) respectively as the counter electrode and the reference electrode.

A. For cleaning of the carbon alloy-coated electrode, cyclic voltammetry was conducted at 20° C., in a 0.1 M aqueous sulfuric acid solution bubbled with argon for 30 minutes or longer, over a sweeping potential range from 0.946 to −0.204 V (vs. SCE), at a sweeping rate of 50 mV/s, repeated 10 cycles.

B. For blank measurement, linear sweep voltammetry was conducted at 20° C., in a 0.1 M aqueous sulfuric acid solution bubbled with argon for 30 minutes or longer, over a sweeping potential range from 0.746 to −0.204 V (vs. SCE), at a sweeping rate of 5 mV/s, at a rotational speed of electrode of 1500 rpm.

C. For measurement of oxygen reduction reaction activity, linear sweep voltammetry was conducted in a 0.5 M aqueous sulfuric acid solution bubbled with argon for 30 minutes or longer, over a sweeping potential range from 0.746 to −0.204V (vs. SCE), at a sweeping rate of 5 mV/s, at a rotational speed of electrode of 1500 rpm.

D. A net oxygen reduction reaction activity was determined by subtracting the measured data in B, from the measured data in C. From the thus obtained voltammogram (current-voltage curve), voltage (V vs. NHE) corresponded to (current density—0.05) mA/cm² was determined and defined as an ORR value.

The result was summarized in Table 1 below.

### Example 2

### Synthesis of Carbon Material Composed of Cobalt(II) Chloride Hexahydrate-Added (4-Py)₄-Por Mixture (20)

### (Preparation of Cobalt(II) Chloride Hexahydrate-Added (4-Py)₄-Por Mixture)

Cobalt(II) chloride hexahydrate-added (4-Py)₄-Por mixture (2A) was obtained, by adding 4.15 g of the above-described (4-Py)₄-Por and 4.15 g of cobalt(II) chloride hexahydrate, followed by mechanical crushing and mixing.

### (Infusibilization and Carbonization)

On a quartz boat, 2.0153 g of cobalt(II) chloride hexahydrate-added (4-Py)₄-Por mixture (2A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 1.3065 g of carbon material (2B).

### (Crushing, Acid Rinsing, and Measurement of Specific Surface Area)

Carbon material (2B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (2C). The thus obtained acid-rinsed carbon material (2C) was denoted as the nitrogen-containing carbon alloy of Example 2. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 2 was used, and ORR value was measured. The result was shown in Table 1 below.

### Example 3

### Synthesis of Carbon Material Composed of Iron(II) Chloride Tetrahydrate-Added (3-Py)₄-Por Mixture (3C)

### (Preparation of (3-Py)₄-Por)

(3-Py)₄-Por was prepared referring to Chemistry Letters, 2007, 36, 848-849.

Synthesis was conducted in the same way as in the preparation of (4-Py)₄-Por in Example 1, except that 4-pyridylaldehyde was replaced with 3-pyridylaldehyde, to thereby obtain 3.1 g of (3-Py)₄-Por (ultramarine powder).

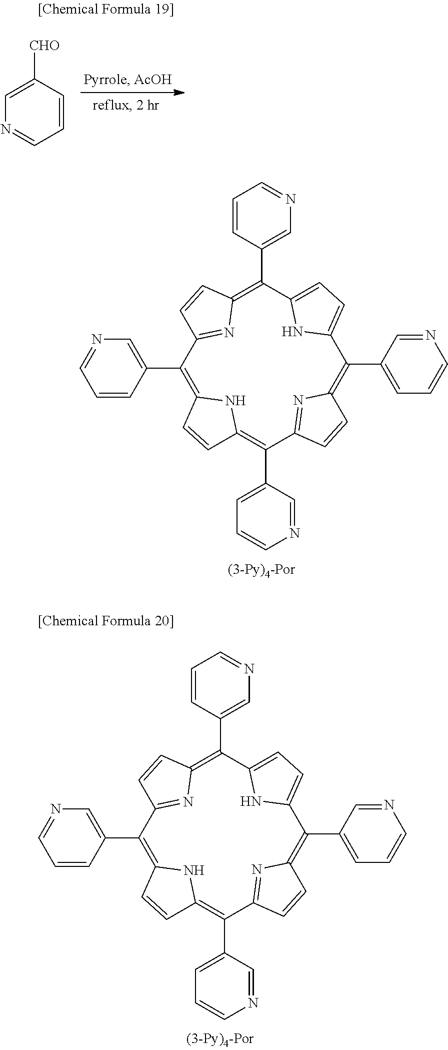 [SMILES: O=Cc1cccnc1 ; C1=Cc2nc1c(-c1cccnc1)c1ccc([nH]1)c(-c1cccnc1)c1nc(c(-c3cccnc3)c3ccc([nH]3)c2-c2cccnc2)C=C1 ; C1=Cc2nc1c(-c1cccnc1)c1ccc([nH]1)c(-c1cccnc1)c1nc(c(-c3cccnc3)c3ccc([nH]3)c2-c2cccnc2)C=C1]

Molecular formula: C₄₀H₂₆N₈, Molecular weight: 618.69

Elemental analysis (calculated value): C, 77.65; H, 4.24; N, 18.11

### (Preparation of Iron(II) Chloride Tetrahydrate-Added (3-Py)₄-Por Mixture)

Iron(II) chloride tetrahydrate-added (3-Py)₄-Por mixture (3A) was obtained, by adding 4.15 g of the above-described (3-Py)₄-Por and 4.15 g of iron(II) chloride tetrahydrate, followed by mechanical crushing and mixing.

On a quartz boat, 2.0218 g of iron(II) chloride tetrahydrate-added (3-Py)₄-Por mixture (3A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 0.9326 g of carbon material (3B).

### (Crushing, Acid Rinsing, and Measurement of Specific Surface Area)

Carbon material (3B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (3C). The thus obtained acid-rinsed carbon material (3C) was denoted as the nitrogen-containing carbon alloy of Example 3. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 3 was used, and ORR value was measured. The result was shown in Table 1 below.

### Example 4

### Synthesis of Carbon Material Composed of Iron(II) Chloride Tetrahydrate-Added (2-Py)₄-Por Mixture (4C)

### (Preparation of (2-Py)₄-Por)

(2-Py)₄-Por was prepared referring to Chemistry Letters, 2007, 36, 848-849.

Synthesis was conducted in the same way as in the preparation of (4-Py)₄-Por in Example 1, except that 4-pyridylaldehyde was replaced with 2-pyridylaldehyde, to thereby obtain 6.2 g of (2-Py)₄-Por (ultramarine powder).

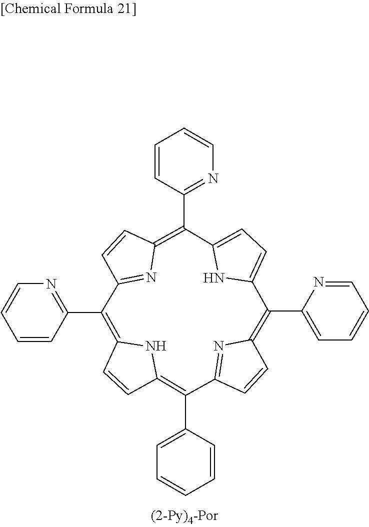 [SMILES: C1=Cc2nc1c(-c1ccccc1)c1ccc([nH]1)c(-c1ccccn1)c1nc(c(-c3ccccn3)c3ccc([nH]3)c2-c2ccccn2)C=C1]

Molecular formula: C₄₀H₂₆N₈, Molecular weight: 618.69

Elemental analysis (calculated value): C, 77.65; H, 4.24; N, 18.11

### (Preparation of Iron(II) Chloride Tetrahydrate-Added (2-Py)₄-Por Mixture)

Iron(II) chloride tetrahydrate-added (2-Py)₄-Por mixture (4A) was obtained, by adding 4.15 g of the above-described (2-Py)₄-Por and 4.15 g of iron(II) chloride tetrahydrate, followed by mechanical crushing and mixing.

### (Infusibilization and Carbonization)

On a quartz boat, 2.0703 g of iron(II) chloride tetrahydrate-added (2-Py)₄-Por mixture (4A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.8053 g of carbon material (4B).

### (Crushing, Acid Rinsing, and Measurement of Specific Surface Area)

Carbon material (4B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively′ allowed to stand overnight, to thereby obtain acid-rinsed carbon material (4C). The thus obtained acid-rinsed carbon material (4C) was denoted as the nitrogen-containing carbon alloy of Example 4. The specific surface area thereof was measured by the BET method. The result was shown in “After acid rinsing” column in Table 1 below.

### (Manufacture of Carbon Alloy-Coated Electrode, and Measurement of Oxygen Reduction (ORR))

A carbon alloy-coated electrode was manufactured in the same way as Example 1, except that the thus obtained nitrogen-containing carbon alloy of Example 4 was used, and ORR value was measured. The result was shown in Table 1 below.

### Example 5

### Synthesis of Carbon Material Composed of Iron(II) Chloride Tetrahydrate-Added (4-Py)₂Ph₂-Por Mixture (5C)

### (Preparation of (Pyrrole)₂(4-Py)CH)

(Pyrrole)₂(4-Py)CH was prepared according to a method described in J. Org. Chem., 2000, 65, 2249-2252.

To 20 mL of pyrrole, 2.14 g of 4-pyridylaldehyde was added, the mixture was heated at 85° C. for 15 hours, pyrrole was distilled off under reduced pressure, and the residue was purified by column chromatography to obtain 2.23 g of (Pyrrole)₂(4-Py)CH.

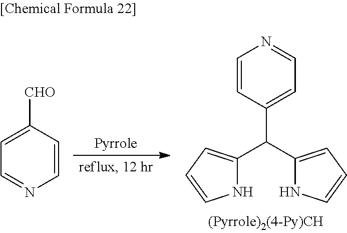 [SMILES: O=Cc1ccncc1 ; c1c[nH]c(C(c2ccncc2)c2ccc[nH]2)c1]

### (Preparation of (4-Py)₂Ph₂-Por)

(4-Py)₂Ph₂-Por was prepared referring to a method described in J. Org. Chem., 2001, 66, 4973-4988.

Into 500 mL of methylene chloride/ethanol mixed solvent (95:5), 1.1 g of (Pyrrole)₂(4-Py)CH described above, and 0.53 g of benzaldehyde were dissolved, 1.4 g of TFA was added under a nitrogen atmosphere over 2 hours, and the mixture was allowed to react for 24 hours at room temperature. Thereafter, 1.7 g of 2,3-dichloro-5,6-dicyano-p-benzoquinone (DDQ) was added, and the mixture was further stirred for 3 hours. The mixture was filtered, and the filtrate was washed with chloroform, and dried. The product was purified by column chromatography to prepare (4-Py)₂Ph₂-Por.

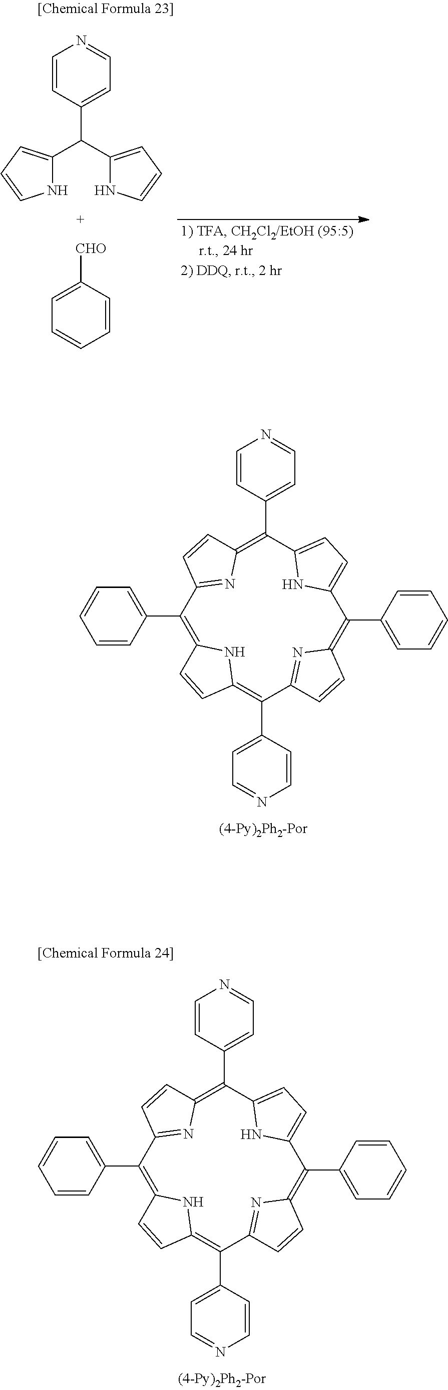 [SMILES: c1c[nH]c(C(c2ccncc2)c2ccc[nH]2)c1 ; O=Cc1ccccc1 ; C1=Cc2nc1c(-c1ccccc1)c1ccc([nH]1)c(-c1ccncc1)c1nc(c(-c3ccccc3)c3ccc([nH]3)c2-c2ccncc2)C=C1 ; C1=Cc2nc1c(-c1ccccc1)c1ccc([nH]1)c(-c1ccncc1)c1nc(c(-c3ccccc3)c3ccc([nH]3)c2-c2ccncc2)C=C1]

Molecular formula: C₄₂H₂₈N₆, Molecular weight: 616.71

Elemental analysis (calculated value): C, 81.80; H, 4.58; N, 13.63

### (Preparation of Iron(II) Chloride Tetrahydrate-Added (4-Py)₂Ph₂-Por Mixture)

Iron(II) chloride tetrahydrate-added (4-Py)₂Ph₂-Por mixture (5A) was obtained, by adding 4.15 g of the above-described (4-Py)₂Ph₂-Por and 4.15 g of iron(II) chloride tetrahydrate, followed by mechanical crushing and mixing.

### (Infusibilization and Carbonization)

On a quartz boat, 2.0456 g of iron(II) chloride tetrahydrate-added (4-Py)₂Ph₂-Por mixture (5A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 0.8161 g of carbon material (5B).

### (Crushing, Acid Rinsing, and Measurement of Specific Surface Area)

Carbon material (5B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (5C). The thus obtained acid-rinsed carbon material (5C) was denoted as the nitrogen-containing carbon alloy of Example 5. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 5 was used, and ORR value was measured. The result was shown in Table 1 below.

### Example 6

### Synthesis of Carbon Material Composed of Iron(II) Chloride Tetrahydrate-Added (4-Py)₃-Cor Mixture (6C)

### (Preparation of (4-Py)₃-Cor)

(4-Py)₃-Cor was prepared referring to a method described in J. Org. Chem., 2001, 66, 550-556.

Into 0.25 liters of ethyl acetate, 2.2 g of 4-pyridylaldehyde (from Wako Pure Chemical Industries, Ltd.) and 4.1 g of pyrrole (from Kanto Chemical Co., Inc.) were dissolved, and the mixture was refluxed under heating, under nitrogen gas flow for 3 hours. Ethyl acetate was then distilled off under reduced pressure, to obtain (4-Py)₃-Cor.

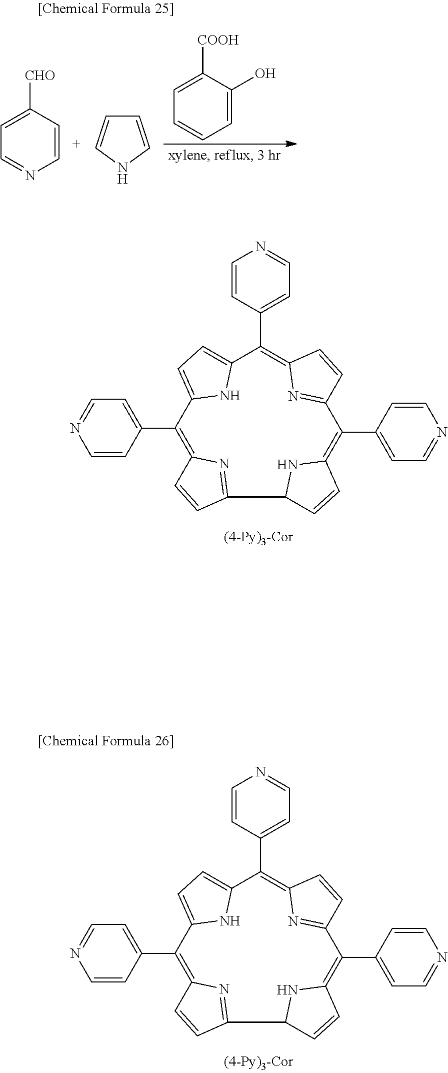

Molecular formula: C₃₄H₂₃N₇, Molecular weight: 529.59

Elemental analysis (calculated value): C, 77.11; H, 4.38; N, 18.51

### (Preparation of Iron(II) Chloride Tetrahydrate-Added (4-Py)₃-Cor Mixture)

Iron(II) chloride tetrahydrate-added (4-Py)₃-Cor mixture (6A) was obtained, by adding 4.15 g of the above-described (4-Py)₃-Cor and 4.15 g of iron(II) chloride tetrahydrate, followed by mechanical crushing and mixing.

### (Infusibilization and Carbonization)

On a quartz boat, 2.0509 g of iron(II) chloride tetrahydrate-added (4-Py)₃-Cor mixture (6A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.9205 g of carbon material (6B).

### (Crushing, Acid Rinsing, and Measurement of Specific Surface Area)

Carbon material (6B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (6C). The thus obtained acid-rinsed carbon material (6C) was denoted as the nitrogen-containing carbon alloy of Example 6. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 6 was used, and ORR value was measured. The result was shown in Table 1 below.

### Example 7

### Synthesis of Carbon Material Composed of Iron(II) Chloride Tetrahydrate-Added H₂AzPc Mixture (7C)

### (Preparation of H₂AzPc)

H₂AzPc was prepared referring to a method described in Synthetic Communications, 2004, 34, 3373-3380, by dissolving 3,4-dicyano pyridine and 1,8-diazabicyclo[5.4.0]undec-7-ene (DBU) into octanol, and by allowing them to react at 185° C. for 2 hours.

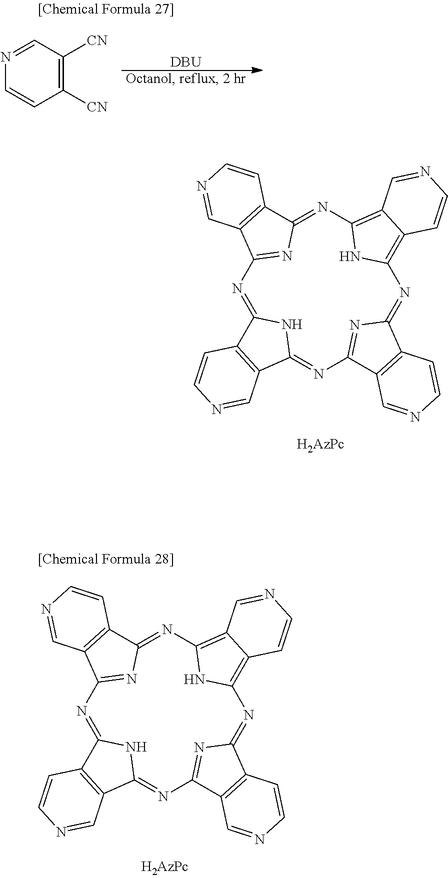 [SMILES: N#Cc1ccncc1C#N ; "DBU" ; "Octanol, reflux, 2 hr" ; c1cc2c(cn1)-c1nc-2nc2[nH]c(nc3nc(nc4[nH]c(n1)c1ccncc41)-c1cnccc1-3)c1ccncc21 ; c1cc2c(cn1)-c1nc-2nc2[nH]c(nc3nc(nc4[nH]c(n1)c1ccncc41)-c1cnccc1-3)c1ccncc21]

Molecular formula: C₂₈H₁₄N₁₂, Molecular weight: 518.49

Elemental analysis (calculated value): C, 64.86; H, 2.72; N, 32.42

### (Preparation of Iron(II) Chloride Tetrahydrate-Added H₂AzPc Mixture)

Iron(II) chloride tetrahydrate-added H₂AzPc mixture (7A) was obtained, by adding 4.15 g of the above-described H₂AzPc and 4.15 g of iron(II) chloride tetrahydrate, followed by mechanical crushing and mixing.

### (Infusibilization and Carbonization)

On a quartz boat, 2.0515 g of iron(II) chloride tetrahydrate-added H₂AzPc mixture (7A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.9191 g of carbon material (7B).

### (Crushing, Acid Rinsing, and Measurement of Specific Surface Area)

Carbon material (7B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (7C). The thus obtained acid-rinsed carbon material (7C) was denoted as the nitrogen-containing carbon alloy of Example 7. The specific surface area thereof was measured by the BET method. The result was shown in “After acid rinsing” column in Table 1 below.

(Manufacture of Carbon Alloy-Coated Electrode, and Measurement of Oxygen Reduction reaction (ORR))

A carbon alloy-coated electrode was manufactured in the same way as Example 1, except that the thus obtained nitrogen-containing carbon alloy of Example 7 was used, and ORR value was measured. The result was shown in Table 1 below.

### Example 8

### Preparation of Carbon Material Composed of Fe(Acac)₂, Iron(II) Chloride Tetrahydrate-Added (4-Py)₄-Por Mixture (8C)

### (Preparation of Fe(acac)₂, Iron(II) Chloride Tetrahydrate-Added (4-Py)₄-Por Mixture)

Fe(acac)₂, iron(II) chloride tetrahydrate-added (4-Py)₄-Por mixture (8A) was obtained, by adding 2.80 g of the above-described (4-Py)₄-Por, 0.180 g of Fe(acac)₂, and 2.80 g of iron(II) chloride tetrahydrate, followed by mechanical crushing and mixing.

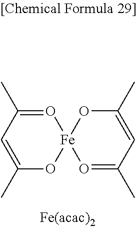

Molecular formula: C₁₀H₁₄Fe₁O₄, Molecular weight: 254.061

Elemental analysis (calculated value): C, 47.27; H, 5.55; Fe, 21.98; O, 25.19

### (Infusibilization and Carbonization)

On a quartz boat, 2.157 g of Fe(acac)₂, iron(II) chloride tetrahydrate-added (4-Py)₄-Por mixture (8A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 1.1782 g of carbon material (8B).

### (Crushing, Acid Rinsing, and Measurement of Specific Surface Area)

Carbon material (8B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (8C). The thus obtained acid-rinsed carbon material (8C) was denoted as the nitrogen-containing carbon alloy of Example 8. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 8 was used, and ORR value was measured. The result was shown in Table 1 below.

### Example 9

### Synthesis of Carbon Material Composed of Fe(Acac)₂, Iron(II) Chloride Tetrahydrate-Added (4-MePy)₄-Por/I Mixture (3C)

### (Preparation of (4-MePy)₄-Por/I)

(4-MePy)₄-Por/I was prepared referring to J. Am. Chem. Soc., 1986, 108, 2814-2828.

In 330 mL of MeI, 6.7 g of the above-described (4-Py)₄-Por was refluxed at 42° C. for 24 hours. CH₃I was then distilled off under reduced pressure, the obtained solid was dissolved into distilled water, the solution was filtered, and the filtrate was concentrated and dried, to thereby obtain 9.5 g of (4-MePy)₄-Por/I.

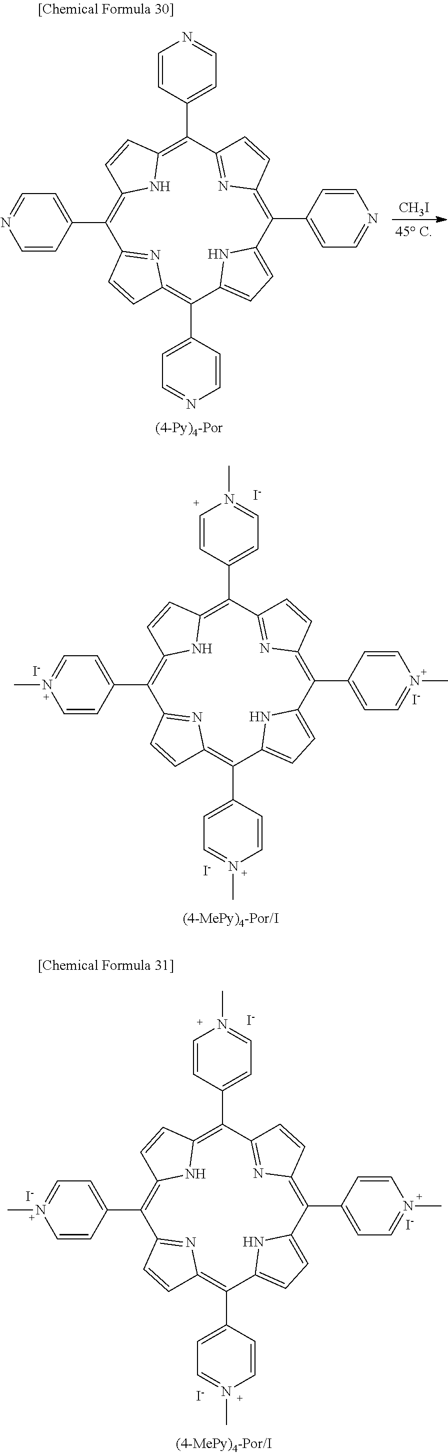

Molecular formula: C₄₄H₃₈I₄N₈, Molecular weight: 1186.44

Elemental analysis (calculated value): C, 44.54; H, 3.23; I, 42.78; N, 9.44

### (Preparation of Fe(Acac)₂, Iron(II) Chloride Tetrahydrate-Added (4-MePy)₄-Por/I Mixture)

Fe(acac)₂, iron(II) chloride tetrahydrate-added (4-MePy)₄-Por/I mixture (9A) was obtained, by adding 4.02 g of the above-described (4-MePy)₄-Por/I, 0.257 g of iron(II) chloride tetrahydrate, and 0.610 g of Fe(acac)₂, followed by mechanical crushing and mixing.

### (Infusibilization and Carbonization)

On a quartz boat, 2.0062 g of Fe(acac)₂, iron(II) chloride tetrahydrate-added (4-MePy)₄-Por/I mixture (9A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.7745 g of carbon material (9B).

### (Crushing, Acid Rinsing, and Measurement of Specific Surface Area)

Carbon material (9B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (9C). The thus obtained acid-rinsed carbon material (9C) was denoted as the nitrogen-containing carbon alloy of Example 9. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 9 was used, and ORR value was measured. The result was shown in Table 1 below.

### Example 10

### Re-Sintering and Acid Rinsing of Carbon Material Composed of Fe(Acac)₂, Iron(II) Chloride Tetrahydrate-Added (4-Py)₄-Por Mixture (10C)

### (Infusibilization and Carbonization)

On a quartz boat, 0.5611 g of acid-rinsed carbon material (8C) of Example 8 was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The nitrogen gas flow was stopped, and the boat was then heated from 30° C. up to 1000° C. at a heating rate of 5° C./min, and then kept at 1000° C. for one hour. The boat was then cooled over 3 hours down to room temperature, to obtain 0.3156 g of carbon material (10B).

### [Crushing, and Acid Rinsing]

Carbon material (10B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (10C). The thus obtained acid-rinsed carbon material (10C) was denoted as the nitrogen-containing carbon alloy of Example 10.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 10 was used, and ORR value was measured. The result was shown in Table 1 below.

### Example 11

### Synthesis of Carbon Material Composed of Fe(acac)₂, iron(II) Chloride Tetrahydrate-Added (4-Py)₂-AzaPor Mixture (11C)

### (Preparation of (Br-Pyrrole)₂(4-Py)CH)

(Br-Pyrrole)₂(4-Py)CH was prepared referring to a method described in Chem. Eur. J., 2012, 18, 6208-6216.

Into 300 mL of tetrahydrofuran (THF), 2.4 g of (Pyrrole)₂(4-Py)CH described in Example 5 was dissolved, and the solution was cooled to −78° C. To the THF solution, 4 g of N-bromosuccinimide (NBS) was added and dissolved, and a THF solution, obtained by dissolving 2.6 g of 2,3-dichloro-5,6-dicyano-p-benzoquinone (DDQ) into 15 mL of THF, was added dropwise. The mixture was heated to room temperature, the solvent was distilled off, and the residue was purified by column chromatography, to thereby prepare (Br-Pyrrole)₂(4-Py)CH.

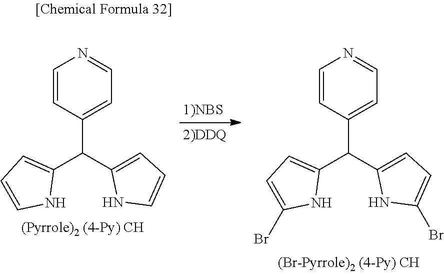 [SMILES: c1c[nH]c(C(c2ccncc2)c2ccc[nH]2)c1 ; Brc1ccc(C(c2ccncc2)c2ccc(Br)[nH]2)[nH]1]

### (Preparation of (4-Py)₂-AzaPor)

(4-Py)₂-AzaPor was prepared referring to a method described in Inorg. Chem., 2012, 51, 12879-12890.

Into 600 mL of methanol, 0.5 g of the above-described (Br-Pyrrole)₂(4-Py)CH, 0.6 g of Pb(acac)₂, and 0.4 g of NaN₃ were dissolved, refluxed under heating, the solvent was then distilled off, the residue was dissolved into 30 mL of CH₂Cl₂, 2 mL of trifluoroacetic acid was added dropwise, and the mixture was stirred at room temperature for one hour. The mixture was then neutralized with NaHCO₃, the product was extracted into an organic layer, the solvent was distilled off to dryness, and the residue was purified by column chromatography, to thereby prepare (4-Py)₂-AzaPor.

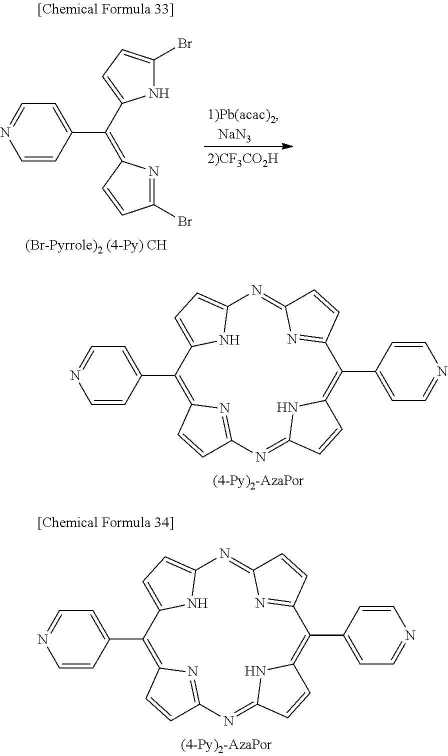

Molecular formula: C₂₈H₁₈N₈, Molecular weight: 466.50

Elemental analysis (calculated value): C, 72.09; H, 3.89; N, 24.02

### (Preparation of Fe(acac)₂, Iron(II) Chloride Tetrahydrate-Added (4-Py)₂-AzaPor Mixture)

Fe(acac)₂, iron(II) chloride tetrahydrate-added (4-Py)₂-AzaPor mixture (11A) was obtained, by adding 6.30 g of the above-described (4-Py)₂-AzaPor, 6.30 g of iron(II) chloride tetrahydrate, and 0.403 g of Fe(acac)₂, followed by mechanical crushing and mixing.

### (Infusibilization and Carbonization)

On a quartz boat, 1.0754 g of Fe(acac)₂, iron(II) chloride tetrahydrate-added (4-Py)₂-AzaPor mixture (11A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 0.3983 g of carbon material (11B).

### (Crushing, Acid Rinsing, and Measurement of Specific Surface Area)

Carbon material (11B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (11C). The thus obtained acid-rinsed carbon material (11C) was denoted as the nitrogen-containing carbon alloy of Example 11. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Example 11 was used, and ORR value was measured. The result was shown in Table 1 below.

### Comparative Example 1

### Synthesis of Carbon Material Composed of FePc (C1C)

### (Infusibilization and Carbonization)

On a quartz boat, 1.0070 g of FePc (C1A, from Tokyo Chemical Industry Co., Ltd.) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 0.6841 g of carbon material (C1B).

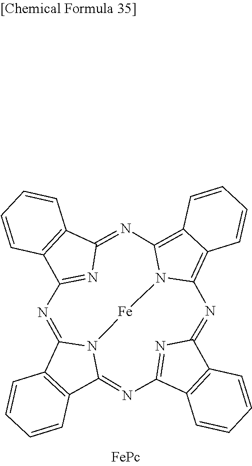

Molecular formula: C₃₂H₁₆Fe₁N₃, Molecular weight: 568.37

Elemental analysis (calculated value): C, 67.62; H, 2.84; Fe, 9.83; N, 19.71

### (Crushing, Acid Rinsing, and Measurement of Specific Surface Area)

Carbon material (C1B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C1C). The thus obtained acid-rinsed carbon material (C1C) was denoted as the nitrogen-containing carbon alloy of Comparative Example 1. The specific surface area thereof was measured by the BET method. The result was shown in “After acid rinsing” column in Table 1 below.

### Comparative Example 2

### Synthesis of Carbon Material Composed of Co-AzPc (C2C)

### (Preparation of Co-AzPc)

Co-AzPc was prepared referring to a method described in Yuki Gosei Kagaku (in Japanese, Journal of Synthetic Organic Chemistry, Japan), 1969, 27, 448-452.

Into 129 g of 1,2,4-trichlorobenzene, 14.7 g of cinchomeronic acid, 0.759 g of ammonium molybdate, and 19.4 g of urea were dissolved, the mixture was stirred under a nitrogen gas atmosphere at 156 to 160° C. for one hour, and thereto 6.66 g of cobalt oxalate, and 15.02 g of urea were added in small portions. The mixture was then stirred at 205 to 210° C. for 3.5 hours, and allowed to stand for one day.

The obtained precipitate was collected by filtration, washed with hexane, hot EtOH, hot water, and a 5% aqueous NaOH solution, further washed with water, and dried. The precipitate was dissolved in 10-fold part, by weight, of concentration sulfuric acid, the mixture was poured into 200-fold part, by weight, of water, the mixture was neutralized with sodium hydroxide, the obtained crystal was collected by filtration under reduced pressure, and washed with warm water, to prepare Co-AzPc.

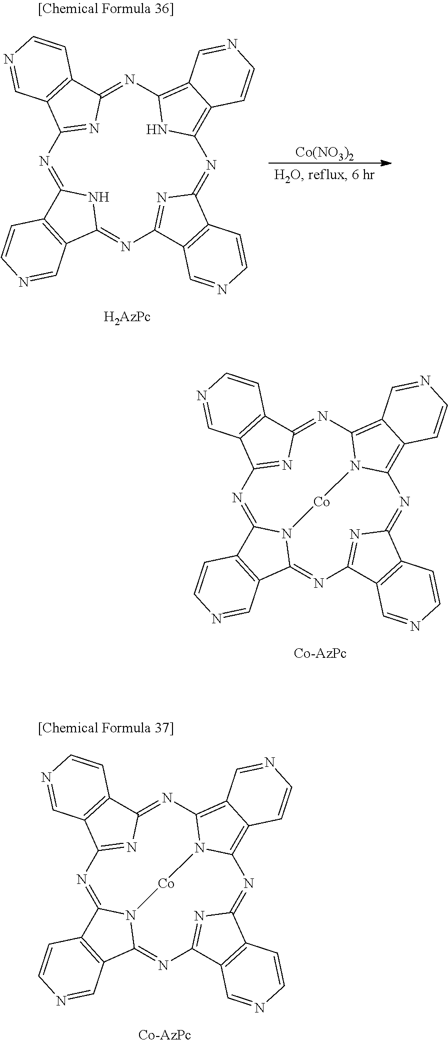

Molecular formula: C₂₈H₁₂Co₁N₁₂, Molecular weight: 575.41

Elemental analysis (calculated value): C, 58.45; H, 2.10; Co, 10.24; N, 29.21

### (Infusibilization and Carbonization)

On a quartz boat, 1.0238 g of Co-AzPc (C2A, from Tokyo Chemical Industry Co., Ltd.) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.3588 g of carbon material (C2B).

### (Crushing, Acid Rinsing, and Measurement of Specific Surface Area)

Carbon material (C2B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C2C). The thus obtained acid-rinsed carbon material (C2C) was denoted as the nitrogen-containing carbon alloy of Comparative Example 2. The specific surface area thereof was measured by the BET method. The result was shown in “After acid rinsing” column in Table 1 below.

### Comparative Example 3

### Synthesis of Carbon Material Composed of Iron(II) Chloride Tetrahydrate-Added H₂Pc Mixture (C3C)

### (Preparation of Iron(II) Chloride Tetrahydrate-Added H₂Pc Mixture)

Iron(II) chloride tetrahydrate-added H₂Pc mixture (C3A) was obtained, by adding 4.15 g of H₂Pc (from Tokyo Chemical Industry Co., Ltd.) and 4.15 g of iron(II) chloride tetrahydrate, followed by mechanical crushing and mixing.

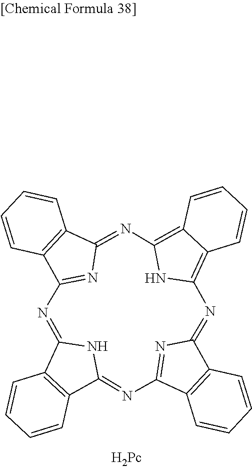 [SMILES: c1ccc2c(c1)-c1nc-2nc2[nH]c(nc3nc(nc4[nH]c(n1)c1ccccc41)-c1ccccc1-3)c1ccccc21]

Molecular formula: C₃₂H₁₈N₈, Molecular weight: 514.17

Elemental analysis (calculated value): C, 70.70; H, 3.53; N, 21.20

### (Infusibilization and Carbonization)

On a quartz boat, 2.0789 g of iron(II) chloride tetrahydrate-added H₂Pc mixture (C3A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 1.1393 g of carbon material (C3B).

### (Crushing, Acid Rinsing, and Measurement of Specific Surface Area)

Carbon material (C3B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C3C). The thus obtained acid-rinsed carbon material (C3C) was denoted as the nitrogen-containing carbon alloy of Comparative Example 3. The specific surface area thereof was measured by the BET method. The result was shown in “After acid rinsing” column in Table 1 below.

### (Manufacture of Carbon Alloy-Coated Electrode, and Measurement of Oxygen Reduction Reaction (ORR))

A carbon alloy-coated electrode was manufactured in the same way as Example 1, except that the thus obtained nitrogen-containing carbon alloy of Comparative Example 3 was used, and ORR value was measured. The result was shown in Table 1 below.

### Comparative Example 4

### Synthesis of Carbon Material Composed of Iron(II) Chloride Tetrahydrate-Added Ph₄-Por Mixture (C4C)

### (Preparation of Iron(II) Chloride Tetrahydrate-Added Ph₄-Por Mixture)

Iron(II) chloride tetrahydrate-added Ph₄-Por mixture (C4A) was obtained, by adding 1.05 g of Ph₄-Por (from Sigma-Aldrich Co. LLC.) and 1.05 g of iron(II) chloride tetrahydrate, followed by mechanical crushing and mixing.

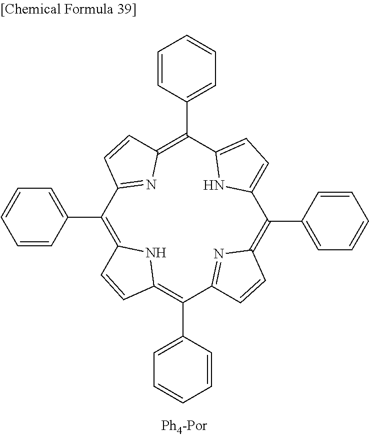 [SMILES: C1=Cc2nc1c(-c1ccccc1)c1ccc([nH]1)c(-c1ccccc1)c1nc(c(-c3ccccc3)c3ccc([nH]3)c2-c2ccccc2)C=C1]

Molecular formula: C₄₄H₃₀N₄, Molecular weight: 614.74

Elemental analysis (calculated value): C, 85.97; H, 4.92; N, 9.11

### (Infusibilization and Carbonization)

On a quartz boat, 2.0607 g of iron(II) chloride tetrahydrate-added Ph₄-Por mixture (C4A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 1.0166 g of carbon material (C4B).

### (Crushing, Acid Rinsing, and Measurement of Specific Surface Area)

Carbon material (C4B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C4C). The thus obtained acid-rinsed carbon material (C4C) was denoted as the nitrogen-containing carbon alloy of Comparative Example 4. The specific surface area thereof was measured by the BET method. The result was shown in “After acid rinsing” column in Table 1 below.

(Manufacture of Carbon Alloy-Coated Electrode, and Measurement of Oxygen Reduction reaction (ORR))

A carbon alloy-coated electrode was manufactured in the same way as Example 1, except that the thus obtained nitrogen-containing carbon alloy of Comparative Example 4 was used, and ORR value was measured. The result was shown in Table 1 below.

### Comparative Example 5

### Synthesis of Carbon Material Composed of Fe(acac)₂, Iron(II) Chloride Tetrahydrate-Added Ph₄-Por Mixture (C5C)

### (Preparation of Fe(acac)₂, Iron(II) Chloride Tetrahydrate-Added Ph₄-Por Mixture)

Fe(acac)₂, iron(II) chloride tetrahydrate-added Ph₄-Por mixture (C5A) was obtained, by adding 1.05 g of Ph₄-Por (from Sigma-Aldrich Co. LLC.), 0.065 g of Fe(acac)₂, and 1.02 g of iron(II) chloride tetrahydrate, followed by mechanical crushing and mixing.

### (Infusibilization and Carbonization)

On a quartz boat, 2.647 g of Fe(acac)₂, iron(II) chloride tetrahydrate-addedPh₄-Por mixture (C5A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./min, and then kept at 700° C. for one hour. The boat was then cooled over 3 hours down to room temperature, to obtain 1.0445 g of carbon material (C5B).

### (Crushing, Acid Rinsing, and Measurement of Specific Surface Area)

Carbon material (C5B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C5C). The thus obtained acid-rinsed carbon material (C5C) was denoted as the nitrogen-containing carbon alloy of Comparative Example 5. The specific surface area thereof was measured by the BET method. The result was shown in “After acid rinsing” column in Table 1 below.

(Manufacture of Carbon Alloy-Coated Electrode, and Measurement of Oxygen Reduction reaction (ORR))

A carbon alloy-coated electrode was manufactured in the same way as Example 1, except that the thus obtained nitrogen-containing carbon alloy of Comparative Example 5 was used, and ORR value was measured. The result was shown in Table 1 below.

### Comparative Example 6

### Synthesis of Carbon Material Composed of Iron(II) Chloride Tetrahydrate-Added Co—Ph₄-Por Mixture (C6C)

### (Preparation of Iron(II) Chloride Tetrahydrate-Added Co—Ph₄-Por Mixture)

Iron(II) chloride tetrahydrate-added Co—Ph₄-Por mixture (C6A) was obtained, by adding 1.05 g of Co—Ph₄-Por (from Sigma-Aldrich Co. LLC.) and 1.05 g of iron(II) chloride tetrahydrate, followed by mechanical crushing and mixing.

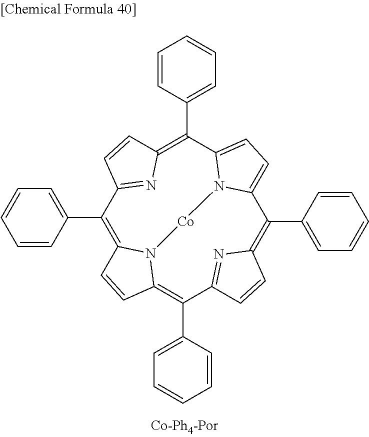

Molecular formula: C₄₄H₂₈Co₁N₄, Molecular weight: 671.65

Elemental analysis (calculated value): C, 78.68; H, 4.20; N, 8.34; Co, 8.77

### (Infusibilization and Carbonization)

On a quartz boat, 1.0431 g of iron(II) chloride tetrahydrate-added Co—Ph₄-Por mixture (C6A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.4672 g of carbon material (C6B).

### (Crushing, Acid Rinsing, and Measurement of Specific Surface Area)

Carbon material (C6B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C6C). The thus obtained acid-rinsed carbon material (C6C) was denoted as the nitrogen-containing carbon alloy of Comparative Example 6. The specific surface area thereof was measured by the BET method. The result was shown in “After acid rinsing” column in Table 1 below.

(Manufacture of Carbon Alloy-Coated Electrode, and Measurement of Oxygen Reduction reaction (ORR))

A carbon alloy-coated electrode was manufactured in the same way as Example 1, except that the thus obtained nitrogen-containing carbon alloy of Comparative Example 6 was used, and ORR value was measured. The result was shown in Table 1 below.

### Comparative Example 7

### Synthesis of Carbon Material Composed of Iron(II) Chloride Tetrahydrate-Added Ph₃-Cor Mixture (C7C)

### (Preparation of Ph₃-Cor)

Ph₃-Cor was prepared referring to a method described in J. Org. Chem., 2001, 66, 550-556.

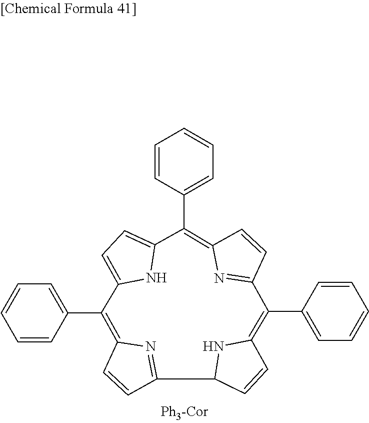 [SMILES: C1=C/C2=C(\c3ccccc3)c3ccc([nH]3)/C(c3ccccc3)=C3/C=CC(=N3)C3C=C/C(=C(\c4ccccc4)C1=N2)N3]

Molecular formula: C₃₇H₂₆N₄, Molecular weight: 526.22

Elemental analysis (calculated value): C, 84.38; H, 4.98; N, 10.64

### (Preparation of Iron(II) Chloride Tetrahydrate-Added Ph₃-Cor Mixture)

Iron(II) chloride tetrahydrate-added Ph₃-Cor mixture (C7A) was obtained, by adding 4.15 g of Ph₃-Cor and 4.15 g of iron(II) chloride tetrahydrate, followed by mechanical crushing and mixing.

### (Infusibilization and Carbonization)

On a quartz boat, 2.0846 g of iron(II) chloride tetrahydrate-added Ph₃-Cor mixture (C7A) was weighed, the boat was placed at the center of a quartz tube of 4.0 cm in diameter (inner diameter=3.6 cm) inserted in a tube furnace, and nitrogen gas was allowed to flow at a flow rate of 300 mL/min for 30 minutes at room temperature.

The boat was heated from 30° C. up to 700° C. at a heating rate of 5° C./rain, and then kept at 700° C. for one hour. The boat was then cooled over 3 hours down to room temperature, to obtain 0.9687 g of carbon material (C7B).

### (Crushing, Acid Rinsing, and Measurement of Specific Surface Area)

Carbon material (C7B) was crushed in an agate mortar, and subjected to rinsing with a concentrated hydrochloric acid, centrifugal filtration, and removal of supernatant, which were repeated until the supernatant was found to be colorless, and followed by rinsing with water, filtration and air drying. The thus obtained carbon material was then heated in vacuo at 110° C. for 3 hours, allowed to cool down to room temperature, and successively allowed to stand overnight, to thereby obtain acid-rinsed carbon material (C7C). The thus obtained acid-rinsed carbon material (C7C) was denoted as the nitrogen-containing carbon alloy of Comparative Example 7. The specific surface area thereof was measured by the BET method. The result was shown in “After acid rinsing” column in Table 1 below.

(Manufacture of Carbon Alloy-Coated Electrode, and Measurement of Oxygen Reduction reaction (ORR))

A carbon alloy-coated electrode was manufactured in the same way as Example 1, except that the thus obtained nitrogen-containing carbon alloy of Comparative Example 7 was used, and ORR value was measured. The result was shown in Table 1 below.

TABLE 1

| | | | | | | | | Properties of N- | | |
|---|---|---|---|---|---|---|---|---|---|---|
| | Condition of manufacturing N-containing carbon alloy | | | | | | | containing carbon | | |
| | | Inorganic metal salt | | | | | | alloy | | |
| | | Organometallic | | | | | | Specific Surface | | Property of |
| | | complex (Catalyst) | | | Ratio of | | | Area by BET | | Carbon Alloy- |
| | | | | Ratio of | inorganic | | | Method (m²/g) | | Coated Electrode |
| | | | | catalyst 2 | metal salt | Sintering | | | Carbon | ORR Voltage at |
| | Nitrogen- | | | (mol %) | (% by mass) | Temperature | | | alloy | 0.05 mg/cm² of |
| | containing | | | (Against | (against | (sintering→ | Nitrogen | Before | isolated | coating |
| | compound | | | metal | base + | re-sintering) | flow | acid | after acid | (current density- |
| | (Base) | Catalyst 1 | Catalyst 2 | catalyst 1) | catalyst) | (° C.) | (mL/min) | rinsing | rinsing | 0.05 mA/cm²) |
| Example 1 | (4-Py)₄-Por | FeCl₂•4H₂O | — | — | 50 | 700 | 300 | 85 | 243 | 0.745 |
| Example 2 | (4-Py)₄-Por | CoCl₂•6H₂O | — | — | 50 | 700 | 300 | 35 | 263 | 0.723 |
| Example 3 | (3-Py)₄-Por | FeCl₂•4H₂O | — | — | 50 | 700 | 300 | 30 | 265 | 0.721 |
| Example 4 | (2-Py)₄-Por | FeCl₂•4H₂O | — | — | 50 | 700 | 300 | 32 | 254 | 0.718 |
| Example 5 | (4-Py)₂Ph₂-Por | FeCl₂•4H₂O | — | — | 50 | 700 | 300 | 28 | 238 | 0.728 |
| Example 6 | (4-Py)₃-Cor | FeCl₂•4H₂O | — | — | 50 | 700 | 300 | 25 | 230 | 0.726 |
| Example 7 | H₂-AzPc | FeCl₂•4H₂O | — | — | 50 | 700 | 300 | 18 | 243 | 0.723 |
| Example 8 | (4-Py)₄-Por | FeCl₂•4H₂O | Fe(acac)₂ | 5 | 48 | 700 | 300 | 15 | 218 | 0.780 |
| Example 11 | (4-Py)₂-AzaPor | FeCl₂•4H₂O | Fe(acac)₂ | 5 | 48 | 700 | 300 | 21 | 235 | 0.748 |
| Example 9 | [(4-MePy)₄- | FeCl₂•4H₂O | Fe(acac)₂ | 5 | 48 | 700 | 300 | 285 | 1108 | 0.725 |
| | Por]⁴⁺•4I⁻ | | | | | | | | | |
| Example 10 | N-containing carbon alloy of Example 8 | | | 5 | 48 | 700→1000 | 300 | — | 670 | 0.792 |
| Comparative | — | FePc | — | — | 0 | 700 | 300 | N.D. | 30 | 0.643 |
| Example 1 | | | | | | | | | | |
| Comparative | — | Co-AzPc | — | — | 0 | 700 | 300 | 45 | 58 | 0.644 |
| Example 2 | | | | | | | | | | |
| Comparative | H₂—Pc | FeCl₂•4H₂O | — | — | 50 | 700 | 300 | 48 | 101 | 0.649 |
| Example 3 | | | | | | | | | | |
| Comparative | Ph₄-Por | FeCl₂•4H₂O | — | — | 50 | 700 | 300 | 26 | 24 | 0.642 |
| Example 4 | | | | | | | | | | |
| Comparative | Ph₄-Por | FeCl₂•4H₂O | Fe(acac)₂ | 5 | 48 | 700 | 300 | 24 | 30 | 0.647 |
| Example 5 | | | | | | | | | | |
| Comparative | Co—Ph₄-Por | FeCl₂•4H₂O | — | — | 48 | 700 | 300 | 31 | 48 | 0.653 |
| Example 6 | | | | | | | | | | |
| Comparative | Ph-Cor | FeCl₂•4H₂O | — | — | 48 | 700 | 300 | 26 | 13 | 0.642 |
| Example 7 | | | | | | | | | | |

Power output of the fuel cell, which is used as an indicator of fuel cell performance, is given by product of voltage and current density, and may be divided into those attributable to catalytic performance, electroconductive component and resistivity component.

It was found from Table 1 that the nitrogen-containing carbon alloys manufactured by the manufacturing method of this invention showed sufficiently high voltage attributable to the catalytic performance.

It was also found that the nitrogen-containing carbon alloys of this invention, which were isolated after the acid rinsing, according to a more preferable manufacturing method of this invention, were largely increased in the specific surface area as compared with the nitrogen-containing carbon alloys before the acid rinsing. The fact that the performance of the nitrogen-containing carbon alloys was largely improved by isolating them after the acid rinsing, was not predictable from JP-A-2011-245431 and other prior art documents which have not directly compared values before and after the acid rinsing.

On the contrary, Comparative Examples were found to show insufficient increase in the specific surface area, and low and insufficient voltage which indicates the catalytic performance.

It was also found that Ph₄-Por, (4-Py)₄-Por, Ph₃-Cor, and H₂AzPc, sintered alone respectively, gave only poor amounts of nitrogen-containing carbon alloys, and the nitrogen-containing carbon alloys showed only low and insufficient voltage.

### INDUSTRIAL APPLICABILITY

According to this invention, a nitrogen-containing carbon alloy having a sufficiently high oxygen reduction reaction may be obtained. Accordingly, nitrogen-containing carbon alloy obtained by the manufacturing method of this invention is usable as a carbon catalyst. The carbon catalyst is preferably used for fuel cells and environmental catalysts, proving its high industrial applicability.

### REFERENCE SIGNS LIST

10 fuel cell
12 eparator
13 node catalyst
14 solid polymer electrolyte
15 cathode catalyst
16 separator
20 electric double-layer capacitor
21 first electrode
22 second electrode
23 separator
24a outer package lid
24b outer package case
25 current collector
26 gasket

What is claimed is:

1. A method for manufacturing a nitrogen-containing carbon alloy,
the method comprising sintering a precursor which contains a nitrogen-containing compound and an inorganic metal salt,
the nitrogen-containing compound having at least one heteroaromatic ring and a conjugated heterocycle, and
the conjugated heterocycle having 12 or larger number of ring-forming atoms.

2. The method for manufacturing a nitrogen-containing carbon alloy of claim 1, wherein the nitrogen-containing compound is represented by the formula (1) below: 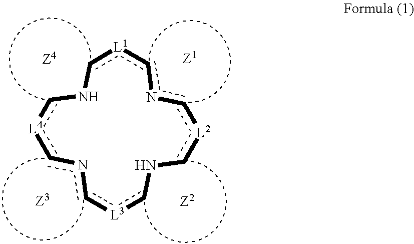
wherein each of L¹ to L⁴ independently represents a linking group, single bond or double bond, each of Z¹ to Z⁴ independently represents a cyclic structure, and at least one of L¹ to L⁴ represents a linking group having a heteroaromatic group, or at least one of Z¹ to Z⁴ contains a heteroaromatic ring.

3. The method for manufacturing a nitrogen-containing carbon alloy of claim 2, wherein the nitrogen-containing compound represented by the formula (1) is represented by the formula (2) below: 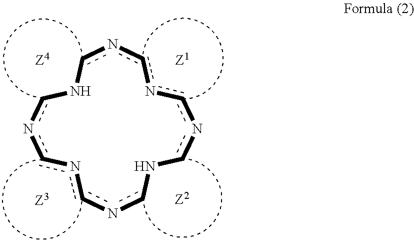
wherein each of Z¹ to Z⁴ independently represents a cyclic structure, and at least one of Z¹ to Z⁴ contains a heteroaromatic ring.

4. The method for manufacturing a nitrogen-containing carbon alloy of claim 2, wherein the nitrogen-containing compound represented by the formula (1) is represented by the formula (3) below: 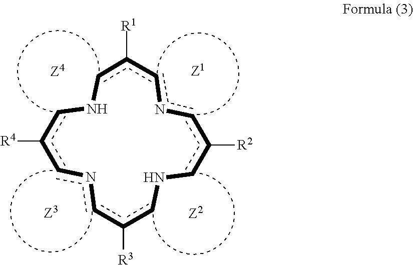
wherein each of R¹ to R⁴ independently represents a hydrogen atom or substituent, each of Z¹ to Z⁴ independently represents a cyclic structure, and at least one of R¹ to R⁴ represents a heteroaromatic group, or at least one of Z¹ to Z⁴ contains a heteroaromatic ring.

5. The method for manufacturing a nitrogen-containing carbon alloy of claim 2, wherein the nitrogen-containing compound represented by the formula (1) is represented by the formula (4) below: 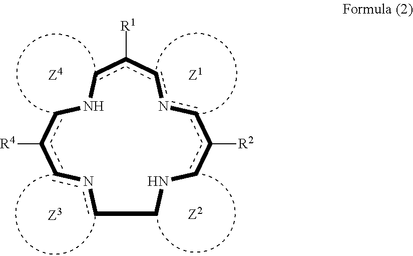
wherein each of R¹, R² and R⁴ independently represents a hydrogen atom or substituent, each of Z¹ to Z⁴ independently represents a cyclic structure, and at least one of R¹, R² and R⁴ represents a heteroaromatic group, or at least one of Z¹ to Z⁴ contains a heteroaromatic ring.

6. The method for manufacturing a nitrogen-containing carbon alloy of claim 2, wherein the nitrogen-containing compound represented by the formula (1) is represented by the formula (5) below: 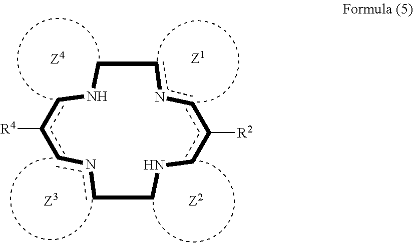
wherein each of R² and R⁴ independently represents a hydrogen atom or substituent, each of Z¹ to Z⁴ independently represents a cyclic structure, and at least one of R² and R⁴ represents a heteroaromatic group, or at least one of Z¹ to Z⁴ contains a heteroaromatic ring.

7. The method for manufacturing a nitrogen-containing carbon alloy of claim 2, wherein the nitrogen-containing compound represented by the formula (1) is represented by the formula (6) below: 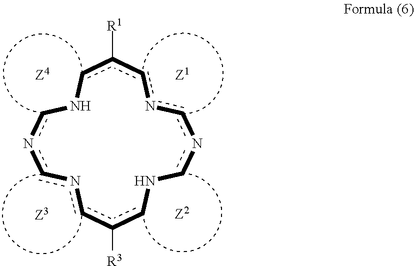
wherein each of R¹ and R³ independently represents a hydrogen atom or substituent, each of Z¹ to Z⁴ independently represents a cyclic structure, and at least one of R¹ and R³ represents a heteroaromatic group, or at least one of Z¹ to Z⁴ contains a heteroaromatic ring.

8. The method for manufacturing a nitrogen-containing carbon alloy of claim 1, wherein the heteroaromatic ring, or the heteroaromatic ring which configures the heteroaromatic group is a six-membered heteroaromatic ring.

9. The method for manufacturing a nitrogen-containing carbon alloy of claim 1, wherein the heteroaromatic ring, or the heteroaromatic ring which configures the heteroaromatic group is a pyridine ring or pyrimidine ring.

10. The method for manufacturing a nitrogen-containing carbon alloy of claim 1, wherein the nitrogen-containing compound has two or more heteroaromatic rings.

11. The method for manufacturing a nitrogen-containing carbon alloy of claim 1, wherein the conjugated heterocycle is a porphyrin ring.

12. The method for manufacturing a nitrogen-containing carbon alloy of claim 1, wherein the nitrogen-containing compound is at least one species selected from pyridylporphyrin excluding metal complex, and, salt of pyridylporphyrin excluding metal complex.

13. The method for manufacturing a nitrogen-containing carbon alloy of claim 1, wherein the precursor further contains an organometallic complex.

14. The method for manufacturing a nitrogen-containing carbon alloy of claim 13, wherein the organometallic complex is a β-diketone metal complex.

15. The method for manufacturing a nitrogen-containing carbon alloy of claim 13, wherein the organometallic complex is iron(II) acetylacetonate complex.

16. The method for manufacturing a nitrogen-containing carbon alloy of claim 1, wherein the inorganic metal salt is an inorganic metal chloride.

17. The method for manufacturing a nitrogen-containing carbon alloy of claim 1, wherein the inorganic metal salt contains Fe or Co as a metal species thereof.

18. The method for manufacturing a nitrogen-containing carbon alloy of claim 1, wherein the inorganic metal salt is a hydrate salt.

19. The method for manufacturing a nitrogen-containing carbon alloy of claim 1, wherein the sintering is carried out by sintering the precursor at 400° C. or above.

20. The method for manufacturing a nitrogen-containing carbon alloy of claim 1, further comprising, succeeding to the sintering, rinsing the sintered nitrogen-containing carbon alloy with an acid.

21. A nitrogen-containing carbon alloy obtainable by a method described in claim 1.

22. A fuel cell catalyst comprising a nitrogen-containing carbon alloy described in claim 21.
